(19) United States
(12) Patent Application Publication
(10) Pub. No.: US 2025/0321156 A1
(43) Pub. Date: Oct. 16, 2025

(54) PAVEMENT CONDITION DETERMINING METHOD, COLLECTION BOX, COMPUTER DEVICE, AND STORAGE MEDIUM

(71) Applicant: TSINGHUA UNIVERSITY, BEIJING (CN)

(72) Inventors: Ya WEI, BEIJING (CN); Chuang YAN, BEIJING (CN); Nuo WU, BEIJING (CN)

(73) Assignee: TSINGHUA UNIVERSITY, BEIJING (CN)

(21) Appl. No.: 19/247,226

(22) Filed: Jun. 24, 2025

Related U.S. Application Data
(63) Continuation of application No. PCT/CN2024/078093, filed on Feb. 22, 2024.

(30) Foreign Application Priority Data
Jun. 21, 2023 (CN) 202310740121.9
Jun. 21, 2023 (CN) 202310744936.4
Jun. 21, 2023 (CN) 202310745212.1

(51) Int. Cl. G01M 7/02; G06N 3/0464; G06N 3/084

(52) U.S. Cl. CPC G01M 7/025; G06N 3/0464; G06N 3/084

(57) ABSTRACT

A pavement condition determining method, a collection box, a computer device, a storage medium, and a computer program product. The pavement condition determining method comprises: acquiring acceleration data and working condition data, the acceleration data being collected by a plurality of acceleration sensors arranged inside the pavement; performing a feature extraction on the acceleration data according to a convolutional neural network of a pavement condition recognition model to obtain acceleration features; splicing each of the acceleration features with corresponding working condition data to determine a target feature vector; and determining a pavement damage identification result based on target feature vectors and a multi-layer perceptron of the pavement condition recognition model.

### CROSS-REFERENCE TO RELATED APPLICATION

The present application is a continuation application of PCT Patent Application No. PCT/CN2024/078093, entitled “PAVEMENT CONDITION IDENTIFYING METHOD AND APPARATUS, PAVEMENT CONDITION MONITORING METHOD AND APPARATUS, PAVEMENT CONDITION EVALUATING METHOD AND APPARATUS, COLLECTION BOX, COMPUTER DEVICE, AND STORAGE MEDIUM”, filed on Feb. 22, 2024, which claims priority to Chinese Patent Application No. 202310744936.4, titled “PAVEMENT DAMAGE IDENTIFYING METHOD, APPARATUS, COMPUTER DEVICE, AND STORAGE MEDIUM”, filed on Jun. 21, 2023, Chinese Patent Application No. 202310745212.1, titled “DATA PROCESSING METHOD, APPARATUS, COMPUTER DEVICE, AND STORAGE MEDIUM”, filed on Jun. 21, 2023, and Chinese Patent Application No. 202310740121.9, titled “PAVEMENT CONDITION EVALUATING METHOD, APPARATUS, STORAGE MEDIUM, AND COLLECTION BOX”, filed on Jun. 21, 2023, the entire contents of which are incorporated herein by reference.

### TECHNICAL FIELD

This application relates to the technical field of pavement damage recognition, and particularly to a pavement condition determining method and apparatus, a collection box, a computer device, a storage medium, and a computer program product.

### BACKGROUND

At present China has the longest highway mileage in the world. However, during a long-term usage, roads are affected by environmental erosion, structural aging, and other factors, thus leading to structural damage of the road. Therefore, a large number of roads need to be maintained, and suitable monitoring means need to be selected for pavement damage monitoring.

### SUMMARY

The present application provides a pavement condition determining method and apparatus, a collection box, a computer device, a computer-readable storage medium, and a computer program product.

The present disclosure provides a pavement condition determining method. The method includes: acquiring acceleration data and working condition data, the acceleration data being collected by a plurality of acceleration sensors arranged inside the pavement; performing a feature extraction on the acceleration data according to a convolutional neural network of a pavement condition recognition model to obtain acceleration features; splicing each of the acceleration features with corresponding working condition data to determine a target feature vector; and determining a pavement damage identification result based on target feature vectors and a multi-layer perceptron of the pavement condition recognition model.

In an embodiment, splicing each of the acceleration features with the corresponding working condition data to determine the target feature vector includes: transforming each of the acceleration feature into a one-dimensional target acceleration feature vector according to a time dimension; and splicing the one-dimensional target acceleration feature vector with the corresponding working condition data to obtain the target feature vector.

In an embodiment, before acquiring the acceleration data and the working condition data, the method further includes: cleaning the acceleration data and the work condition data to obtain cleaned acceleration data and cleaned work condition data; and performing a data processing on the cleaned acceleration data and the cleaned working condition data according to a mean-variance normalization method to obtain normalized acceleration data and normalized working condition data.

In an embodiment, determining the pavement damage identification result based on the target feature vectors and the multi-layer perceptron of the pavement condition recognition model includes: processing and identifying each of the target feature vectors according to the multi-layer perceptron to obtain a probability of a pavement damage classification result; and determining the pavement damage identification result based on probabilities of pavement damage classification results.

In an embodiment, the method further includes: acquiring acceleration samples, acceleration sample labels and working condition samples, each of the acceleration sample labels being configured to characterize a pavement damage identification result of a corresponding acceleration sample under conditions of a corresponding working condition sample; performing a feature extraction on each acceleration sample according to a convolutional neural network of a to-be-trained pavement condition recognition model to obtain a training acceleration feature; splicing the training acceleration feature with a corresponding working condition sample to determine a training target feature vector; determining a pavement damage identification result based on the training target feature vector and the multi-layer perceptron of the to-be-trained pavement condition recognition model; and determining a loss value of the to-be-trained pavement condition recognition model according to the training pavement damage identification result and a corresponding acceleration sample label, and stopping training the to-be-trained pavement condition recognition model when the loss value satisfies a predetermined loss condition to obtain a trained pavement condition recognition model.

In an embodiment, steps of determining the loss value of the pavement condition recognition model according to the training pavement damage identification result and the acceleration sample label, and stopping training the to-be-trained pavement condition recognition model when the loss value satisfies the predetermined loss condition to obtain the trained pavement condition recognition model includes: calculating a gradient of the to-be-trained pavement condition recognition model through a back propagation algorithm, updating model parameters of the to-be-trained pavement condition recognition model through an optimizer of a gradient descent algorithm to obtain the to-be-trained pavement condition recognition model with updated model parameters; performing step of performing the feature extraction on each acceleration sample according to the convolutional neural network of the to-be-trained pavement condition recognition model to obtain the training acceleration feature, until the loss value satisfies a predetermined loss condition; and stopping training the to-be-trained pavement condition recognition model, determining current model parameters of the to-be-trained pavement condition recognition model as trained model parameters, and obtaining the trained pavement condition recognition model.

The present disclosure also provides a computer device. The computer device includes a memory and a processor. The memory has a computer program stored thereon. The processor, when executing the computer program, implements the following steps: acquiring acceleration data and working condition data, the acceleration data being collected by a plurality of acceleration sensors arranged inside the pavement; performing a feature extraction on the acceleration data according to a convolutional neural network of a pavement condition recognition model to obtain acceleration features; splicing each of the acceleration features with corresponding working condition data to determine a target feature vector; and determining a pavement damage identification result based on target feature vectors and a multi-layer perceptron of the pavement condition recognition model.

The present disclosure also provides a non-transitory computer readable storage medium, having a computer program stored thereon. The computer program, when executed by a processor, implements the following steps: acquiring acceleration data and working condition data, the acceleration data being collected by a plurality of acceleration sensors arranged inside the pavement; performing a feature extraction on the acceleration data according to a convolutional neural network of a pavement condition recognition model to obtain acceleration features; splicing each of the acceleration features with corresponding working condition data to determine a target feature vector; and determining a pavement damage identification result based on target feature vectors and a multi-layer perceptron of the pavement condition recognition model.

The present disclosure also provides a computer program product. The computer program product includes executable instructions. The executable instructions, when executed by a processor, implement the following steps: acquiring acceleration data and working condition data, the acceleration data being collected by a plurality of acceleration sensors arranged inside the pavement; performing a feature extraction on the acceleration data according to a convolutional neural network of a pavement condition recognition model to obtain acceleration features; splicing each of the acceleration features with corresponding working condition data to determine a target feature vector; and determining a pavement damage identification result based on target feature vectors and a multi-layer perceptron of the pavement condition recognition model.

In the above pavement condition determining method and apparatus, the computer device, the storage medium, and the computer program product, the feature extraction is performed on the acceleration data by the convolutional neural network of the pavement condition recognition model to obtain the acceleration features, which can monitor the internal damage of the pavement, and each of the acceleration features are spliced with the corresponding working condition data to obtain a target feature vector, which can improve the complexity of the target feature vector, so that the generalization ability of the classification computation performed on the target feature vectors by the multi-layer perceptron of the pavement condition recognition model is improved, thereby improving the accuracy of the pavement damage recognition.

The present disclosure also provides a pavement condition determining method. The method includes: acquiring a detected acceleration sequence collected by a detection sensor and a reference acceleration sequence collected by a reference sensor within a detection time window, the detection sensor and the reference sensor being arranged according to a travelling direction of a road to be detected; predicting the detected acceleration sequence based on a prediction model to obtain a predicted acceleration sequence, and constructing a mapping relationship between the detected sensor and the reference sensor based on the predicted acceleration sequence and the reference acceleration sequence; and determining a damage level of the road to be detected based on the mapping relationship and damage level intervals.

In an embodiment, the detection sensor and the reference sensor are arranged along the same straight line or at a slab corner in the travelling direction of the road to be detected according to the travelling direction of the road to be detected.

In an embodiment, constructing the mapping relationship between the detection sensor and the reference sensor based on the predicted acceleration sequence and the reference acceleration sequence includes: establishing a mapping relationship between a predicted acceleration in the predicted acceleration sequence and a reference acceleration of the same moment in the reference acceleration sequence; performing a data processing on the predicted acceleration in the predicted acceleration sequence and the reference acceleration in the reference acceleration sequence according to a predetermined root-mean-square algorithm and the mapping relationship, to obtain a root mean square error (RMSE); and determining the RMSE to be a deviation value between the detection sensor and the reference sensor.

In an embodiment, determining the damage level of the road to be detected based on the mapping relationship and the damage level intervals includes: performing a data processing on the reference acceleration sequence according to a predetermined standard deviation algorithm to obtain a standard deviation; determining a damage value of the road to be detected based on the standard deviation and the deviation value corresponding to the mapping relationship; and determining the damage level corresponding to the damage value of the road to be detected based on the damage level intervals.

In an embodiment, after determining the damage level of the road to be detected based on the mapping relationship and the damage level intervals, the method further includes: determining whether the damage level satisfies a predetermined reporting condition; acquiring location information of the road to be detected corresponding to the damage level satisfies the reporting condition; and constructing reporting information based on the location information and the damage level of the road to be detected, and forwarding the reporting information to target personnel.

In an embodiment, before predicting the detected acceleration sequence based on the prediction model to obtain the predicted acceleration sequence, the method further includes: acquiring a training dataset, the training dataset including a detection training subset and a reference training subset, the detection training subset and the reference training subset comprise acceleration data of the road in a normal condition; and training a predetermined Long Short-Term Memory (LSTM) artificial neural network based on the training dataset until a trained LSTM artificial neural network satisfies a predetermined training stop condition, and using the trained LSTM artificial neural network satisfying the predetermined training stop condition as the prediction model.

In an embodiment, acquiring the training dataset includes: acquiring a detection training set and a reference training set; the detection training set comprising a plurality of detection training data collected by the detection sensor, and the reference training set comprising a plurality of reference training data collected by the reference sensor; dividing the detection training set and the reference training set according to the detection time window to obtain a plurality of detection training subsets corresponding to the detection training set and a plurality of reference training subsets corresponding to the reference training respectively; and constructing a training dataset based on the detection training subsets and the reference training subsets.

The present disclosure also provides a computer device. The computer device includes a memory and a processor. The memory has a computer program stored thereon, the processor, when executing the computer program, implements the following steps: acquiring a detected acceleration sequence collected by a detection sensor and a reference acceleration sequence collected by a reference sensor within a detection time window, the detection sensor and the reference sensor being arranged according to a travelling direction of a road to be detected; predicting the detected acceleration sequence based on a prediction model to obtain a predicted acceleration sequence, and constructing a mapping relationship between the detected sensor and the reference sensor based on the predicted acceleration sequence and the reference acceleration sequence; and determining a damage level of the road to be detected based on the mapping relationship and damage level intervals.

The present disclosure also provides a non-transitory computer-readable storage medium. The computer-readable storage medium having a computer program stored thereon. The computer program, when executed by a processor, implements the following steps: acquiring a detected acceleration sequence collected by a detection sensor and a reference acceleration sequence collected by a reference sensor within a detection time window, the detection sensor and the reference sensor being arranged according to a travelling direction of a road to be detected; predicting the detected acceleration sequence based on a prediction model to obtain a predicted acceleration sequence, and constructing a mapping relationship between the detected sensor and the reference sensor based on the predicted acceleration sequence and the reference acceleration sequence; and determining a damage level of the road to be detected based on the mapping relationship and damage level intervals.

The present disclosure also provides a computer program product including executable instructions, the executable instructions, when executed by a processor, implement the following steps: acquiring a detected acceleration sequence collected by a detection sensor and a reference acceleration sequence collected by a reference sensor within a detection time window, the detection sensor and the reference sensor being arranged according to a travelling direction of a road to be detected; predicting the detected acceleration sequence based on a prediction model to obtain a predicted acceleration sequence, and constructing a mapping relationship between the detected sensor and the reference sensor based on the predicted acceleration sequence and the reference acceleration sequence; and determining a damage level of the road to be detected based on the mapping relationship and damage level intervals.

In the above pavement condition determining method, apparatus, computer device, storage medium and computer program product, a detected acceleration sequence collected by a detection sensor and a reference acceleration sequence collected by a reference sensor within a detection time window are acquired. The detection sensor and the reference sensor are arranged according to a travelling direction of a road to be detected. The detected acceleration sequence is predicted based on a prediction model to obtain a predicted acceleration sequence, and a mapping relationship between the detected sensor and the reference sensor is constructed based on the predicted acceleration sequence and the reference acceleration sequence. a damage level of the road to be detected is determined based on the mapping relationship and damage level intervals. By the present method, the mapping relationship between the acceleration of a detection sensor arranged in a road and the acceleration of a reference sensor is constructed, a change in a vibration signal is obtained when a damage occurs inside a road. Furthermore, by determining the damage level of the road based on the mapping relationship and the damage level intervals, the damage inside the road is identified and the damage level inside the road is determined, thereby improving the accuracy of the pavement condition determining method.

The present disclosure further provides a pavement condition determining method. The method is applied to a control module of a collection box; the collection box comprises a switch and an external environment detection sensor; the switch is electrically connected to the control module and the external environment detection sensor; the collection box is electrically connected to each acceleration sensor arranged on a road. The method includes: acquiring an acceleration signal sequence collected by each acceleration sensor, and acquiring external environment data collected by the external environment detection sensor through the switch; determining a processing parameter for the acceleration signal sequence based on the external environmental data and according to a predetermined parameter determination strategy; performing a feature extraction on the acceleration signal sequence based on the processing parameter to obtain a feature value corresponding to the acceleration signal sequence; and evaluating the feature value according to a predetermined condition evaluation strategy to obtain an evaluation result of the pavement condition.

In an embodiment, determining the processing parameter for the acceleration signal sequence based on the external environmental data and according to the predetermined parameter determination strategy includes determining an acceleration interception threshold interval for the acceleration signal sequence based on the external environmental data and according to the predetermined parameter determination strategy. Performing the feature extraction on the acceleration signal sequence based on the processing parameter to obtain a feature value corresponding to the acceleration signal sequence includes: intercepting a valid acceleration signal sub-sequence among the acceleration signal sequence based on the acceleration interception threshold interval; and performing a feature extraction on the valid acceleration signal sub-sequence to obtain feature values corresponding to the acceleration signal sequence.

In an embodiment, intercepting the valid acceleration signal sub-sequence among the acceleration signal sequence based on the acceleration interception threshold interval includes: searching, among the acceleration signal sequence, a first starting acceleration signal value not within the acceleration interception threshold interval; determining an acceleration signal sub-sequence having the first starting acceleration signal value as a starting acceleration signal to be a valid acceleration signal sub-sequence corresponding to a case where, except the first starting acceleration signal value, at least one acceleration signal value among the acceleration signal values in the acceleration signal sub-sequence within a predetermined time period is not within the acceleration interception threshold interval; and searching, among the acceleration signal sequence, a second starting acceleration signal value not within the acceleration interception threshold interval, corresponding to a case where except the first starting acceleration signal value, each acceleration signal value in the acceleration signal sub-sequence within the predetermined time period is within the acceleration interception threshold interval.

In an embodiment, determining the processing parameter for the acceleration signal sequence based on the external environmental data and according to the predetermined parameter determination strategy includes determining a window length for the acceleration signal sequence based on the external environmental data and according to the predetermined parameter determination strategy.

Performing the feature extraction on the acceleration signal sequence based on the processing parameter to obtain a feature value corresponding to the acceleration signal sequence includes: filtering the acceleration signal sequence by the window length to obtain a filtered acceleration signal sequence; and performing a feature extraction on the filtered acceleration signal sequence to obtain feature values corresponding to the acceleration signal sequence.

In an embodiment, determining the processing parameter for the acceleration signal sequence based on the external environmental data and according to the predetermined parameter determination strategy comprises: determining an acceleration interception threshold interval and a window length for the acceleration signal sequence based on the external environmental data and according to the predetermined parameter determination strategy.

Performing the feature extraction on the acceleration signal sequence based on the processing parameter to obtain a feature value corresponding to the acceleration signal sequence includes: intercepting a valid acceleration signal sub-sequence among the acceleration signal sequence based on the acceleration interception threshold interval; filtering the valid acceleration signal sub-sequence by the window length to obtain a filtered acceleration signal sequence; and performing a feature extraction on the filtered acceleration signal sequence to obtain feature values corresponding to the acceleration signal sequence.

In an embodiment, the collecting box further includes an anti-condensation dehumidifier, a radiator, and an internal environment detection sensor, the anti-condensation dehumidifier is electrically connected to the switch, the radiator is electrically connected to the switch, and the internal environment detection sensor is electrically connected to the switch. The method further includes: obtaining internal environment data collected by the internal environment detection sensor through the switch; sending a starting instruction to the anti-condensation dehumidifier through the switch in the case that internal environment humidity data in the internal environment data reaches a predetermined internal environment humidity threshold; and sending a starting instruction to the radiator through the switch in the case that internal environment temperature data in the internal environment data reaches a predetermined internal environment temperature threshold.

In an embodiment, the collection box further includes a communication module electrically connected to the switch.

Acquiring the acceleration signal sequence collected by each acceleration sensor, and acquiring external environment data collected by the external environment detection sensor through the switch includes: receiving a remote user instruction forwarded by the communication module through the switch; acquiring the acceleration signal sequence collected by each acceleration sensor upon arrival of a collection start time corresponding to the remote user instruction, and acquire the external environment data collected by the external environment detection sensor through the switch.

The present disclosure also provides a collection box. The collection box includes a control module, a switch, and an external environment detection sensor. T the switch is electrically connected to the control module and the external environment detection sensor, and the collection box is electrically connected to each acceleration sensor arranged inside the road.

The switch is configured to exchange data between the control module and the external environment detection sensor.

The external environment detection sensor is configured to collect data on the external environment of the collection box.

The control module is configured to perform any one of the pavement condition determining methods above.

In an embodiment, the collection box further includes the anti-condensation dehumidifier, the radiator, and the internal environment collection sensor.

The anti-condensation dehumidifier is configured to perform dehumidification on the collection box according to the control of the control module.

The radiator is configured to dissipate heat of the collection box according to the control of the control module.

The internal environment collection sensor is configured to collect internal environment data from the collection box.

The present disclosure also provides a pavement condition determining apparatus. The apparatus is applied to a control module of a collection box. The collection box includes a switch, and an external environment detection sensor. The switch is electrically connected to the control module and the external environment detection sensor. The collection box is electrically connected to each acceleration sensor arranged inside the road. The apparatus includes: a fourth acquisition module, a processing-parameter determination module, a third feature extraction module and an evaluation module.

The fourth acquisition module is configured to acquire an acceleration signal sequence collected by each acceleration sensor, and acquire external environment data collected by the external environment detection sensor through the switch.

The processing-parameter determination module is configured to determine a processing parameter for the acceleration signal sequence based on the external environmental data and according to a predetermined parameter determination strategy.

The third feature extraction module is configured to perform a feature extraction on the acceleration signal sequence based on the processing parameter to obtain a feature value corresponding to the acceleration signal sequence.

The evaluation module is configured to evaluate the feature value according to a predetermined condition evaluation strategy to obtain an evaluation result of the pavement condition.

In an embodiment, the collection box further includes an anti-condensation dehumidifier, a radiator, an internal environment detection sensor. The anti-condensation dehumidifier is electrically connected to the switch, the radiator is electrically connected to the switch, and the internal environment detection sensor is electrically connected to the switch. The apparatus further includes: an internal environment data acquisition module, an anti-condensation dehumidifier starting module and a radiator starting module.

The internal environment data acquisition module is configured to obtain, through the switch, internal environment data collected by the internal environment detection sensor.

The anti-condensation dehumidifier starting module is configured to send a start instruction to the anti-condensation dehumidifier through the switch in the case that the internal environment humidity data in the internal environment data reaches a predetermined internal environment humidity threshold.

The radiator starting module is configured to send a starting instruction to the radiator through the switch in the case that internal environment temperature data in the internal environment data reaches a predetermined internal environment temperature threshold.

In an embodiment, the collection box further includes a communication module electrically connected to the switch. The apparatus further including a receiving module.

The receiving module is configured to receive, through the switch, remote user instructions forwarded by the communication module.

In an embodiment, the fourth acquisition module is configured to: acquire the acceleration signal sequence collected by each acceleration sensor upon arrival of a collection start time corresponding to the remote user instruction, and acquire the external environment data collected by the external environment detection sensor through the switch.

The present disclosure also provides a computer readable storage medium. The computer-readable storage medium has a computer program stored thereon. The computer program, when executed by a processor, implements the following steps: acquiring an acceleration signal sequence collected by each acceleration sensor, and acquiring external environment data collected by the external environment detection sensor through the switch; determining a processing parameter for the acceleration signal sequence based on the external environmental data and according to a predetermined parameter determination strategy; performing a feature extraction on the acceleration signal sequence based on the processing parameter to obtain a feature value corresponding to the acceleration signal sequence; and evaluating the feature value according to a predetermined condition evaluation strategy to obtain an evaluation result of the pavement condition.

The present disclosure also provides a computer program product. The computer program product includes executable instructions. The executable instructions, when executed by a processor, perform the following steps: acquiring an acceleration signal sequence collected by each acceleration sensor, and acquiring external environment data collected by the external environment detection sensor through the switch; determining a processing parameter for the acceleration signal sequence based on the external environmental data and according to a predetermined parameter determination strategy; performing a feature extraction on the acceleration signal sequence based on the processing parameter to obtain a feature value corresponding to the acceleration signal sequence; and evaluating the feature value according to a predetermined condition evaluation strategy to obtain an evaluation result of the pavement condition.

The above pavement condition determining method and apparatus, the storage medium, the computer program product, and the collection box consider that the external environment condition directly affects the pavement condition, thus adjusting and determining each processing parameter for the acceleration data through the external environmental data, so that the processing of the acceleration data can be adjusted in accordance with the effects of the environment, thereby enabling the acceleration data to be processed more accurately, and obtaining a more accurate evaluation result.

### BRIEF DESCRIPTION OF THE DRAWINGS

FIG. 1 is a view showing an application environment of a pavement condition determining method according to an embodiment of the present disclosure.

FIG. 2 is a schematic flowchart of a pavement condition determining method according to an embodiment of the present disclosure.

FIG. 3 is a schematic view showing convolutional kernels and input data of a convolutional neural network according to an embodiment of the present disclosure.

FIG. 4 is a schematic flowchart of a data concatenation method according to an embodiment of the present disclosure.

FIG. 5 is a schematic flowchart of a preprocessing method according to an embodiment of the present disclosure.

FIG. 6 is a schematic flowchart of a method for determining pavement damage classification results according to an embodiment of the present disclosure.

FIG. 7 is a schematic flowchart of a method for training a pavement condition recognition model according to an embodiment of the present disclosure.

FIG. 8 is a schematic flowchart of an iterative training method for the pavement condition recognition model according to an embodiment of the present disclosure.

FIG. 9 is a block diagram showing a structure of a pavement condition determining apparatus according to an embodiment of the present disclosure.

FIG. 10 is a view showing an internal structure of a computer device according to an embodiment of the present disclosure.

FIG. 11 is a schematic flowchart of a pavement condition determining method according to an embodiment of the present disclosure.

FIG. 12 is a schematic flowchart of a step of constructing a mapping relationship according to an embodiment of the present disclosure.

FIG. 13 is a schematic flowchart of a step of determining a damage level according to an embodiment of the present disclosure.

FIG. 14 is a schematic flowchart of a step of feedbacking information report according to an embodiment of the present disclosure.

FIG. 15 is a schematic flowchart of a step of training a prediction model according to an embodiment of the present disclosure.

FIG. 16 is a schematic flowchart of a step of constructing a training dataset according to an embodiment of the present disclosure.

FIG. 17 is a schematic flowchart of a pavement condition determining method according to an embodiment of the present disclosure.

FIG. 18 is a schematic flowchart of the pavement condition determining method according to another embodiment of the present disclosure.

FIG. 19 is a block diagram showing a structure of a pavement condition determining apparatus according to an embodiment of the present disclosure.

FIG. 20 is a view showing an application environment diagram of a pavement condition determining method according to an embodiment of the present disclosure.

FIG. 21 is a schematic view showing an arrangement of acceleration sensors according to an embodiment of the present disclosure.

FIG. 22 is a schematic flowchart of a pavement condition determining method according to an embodiment of the present disclosure.

FIG. 23 is a schematic view showing a collection box according to an embodiment of the present disclosure.

FIG. 24 is a schematic view showing the collection box according to another embodiment of the present disclosure.

FIG. 25A is an external schematic view of a collection box according to an embodiment of the present disclosure.

FIG. 25B is an internal schematic view of the collection box according to an embodiment of the present disclosure.

FIG. 26 is a view showing an internal connection of the collection box according to an embodiment of the present disclosure.

FIG. 27 is a block diagram showing a structure of a pavement condition determining apparatus according to an embodiment of the present disclosure.

### DETAILED DESCRIPTION OF THE EMBODIMENTS

To make the objectives, technical solutions, and advantages of the present disclosure clearer and better understood, the application will be further described in detail with reference to the accompanying drawings and embodiments. It should be understood that the described embodiments are intended to explain the application but not intended to limit the application.

In related technologies, image processing is predominantly used in road management and maintenance to monitor surface damage to the roads. Image processing involves methods for classifying and splitting road images and detecting damage targets. Pavement images are manually annotated and inputted into a convolutional neural network (CNN) for training. The trained CNN is then used to determine whether pavement images contain damage types such as cracks or potholes.

However, the existing monitoring of roads based on image processing can only monitor the surface damages to the road but cannot determine the actual level of damage within the road to be detected. For cement pavement, a void damage in road slab is the most fundamental damage, and when a surface damage occurs in the pavement, it is often caused by a previously occurred cavity beneath slab. Therefore, the accuracy of pavement damage results determined by existing pavement condition determining methods is low, and there is an urgent need for a method that can monitor internal damage in the road.

The pavement condition determining method provided in the embodiments of the present disclosure may be applied to an application environment shown in FIG. 1. A working condition collection device 110 is connected to acceleration sensors 120. The working condition collection device 110 can share data collected by weighing scales use them as parameters in working condition data and share acceleration data collected by the acceleration sensors 120. The working condition collection device 110 transmits the working condition data and acceleration data to a terminal 130 via a network for a pavement condition recognition process. Additionally, sensors such as radar and environmental sensors for collecting the working condition data are integrated into the working condition collection device 110.

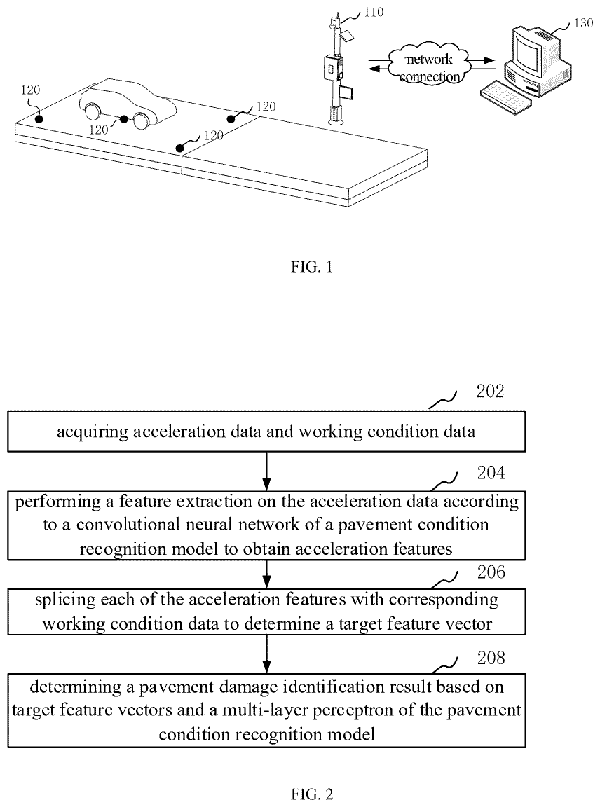

In an embodiment, as shown in FIG. 2, a pavement condition determining method is provided. This method is described by taking it applied to the terminal 130 in FIG. 1 as an example. It should be understood that the method may also be applied to a server, or may be applied to a system including a terminal and a server and implemented through an interaction between the terminal and server. In an embodiment, the method includes the following steps 202 to 208.

In Step 202, acquire acceleration data and working condition data.

The acceleration data are collected by multiple acceleration sensors arranged inside the pavement.

In an embodiment, when a vehicle passes over a pavement that is under monitoring, the pavement interacts with tires and generates vibration, and an acceleration sensor arranged inside the pavement collects a vibration signal, and a data processing is performed on the vibration signal, and vibration acceleration data generated by the pavement when the current vehicle passes over are obtained and used as acceleration data. In an embodiment, due to the limitation of a response frequency of a road structure, a sampling frequency of each acceleration sensor may be set to 100 Hz (hertz), and a length of the acquired signal may be intercepted as 10 seconds.

The condition acquisition device may collect environmental information parameters of the environment in which the pavement is under monitoring. For example, environment temperature and humidity of a current pavement are collected by a temperature and humidity sensor, etc. The radar integrated in the condition acquisition device may also monitor the speed information of a vehicle passing by, and obtain the speed of the vehicle. In addition, the condition acquisition device can obtain a type of the vehicle passing by through the integrated monitoring device, obtain an axle weight and a total mass of the vehicle passing by through a load-bearing device sharing data with the condition acquisition device, and record the type of the vehicle passing by (e.g., a truck, a bus, a car, etc.), and the condition acquisition device can also preset a road structure size and a joint form of the pavement under monitoring, etc., which can be used as the working condition data acquired by the condition acquisition device. Thus, the terminal for recognizing damage to the pavement may acquire acceleration data of the pavement based on the acceleration sensors, and acquire working condition data based on the working condition acquisition device.

In Step 204, perform a feature extraction on the acceleration data according to a convolutional neural network of the pavement condition recognition model to obtain acceleration features.

In the embodiment of the present disclosure, when the pavement condition recognition is performed, the pavement load action has the same recognition result at any position within the interception time, therefore, in the embodiments of the present disclosure, based on the principle of weight sharing of a convolutional neural network, the terminal performs feature extraction on the acceleration data by means of a multi-layer convolutional neural network to identify the type of damage of the pavement. The terminal inputs the acquired acceleration data collected by each acceleration sensor into the channels of the convolutional neural network, and performs a feature extraction on the acceleration data from different acceleration sensors through a convolution operation, and obtains acceleration features in a form of a matrix.

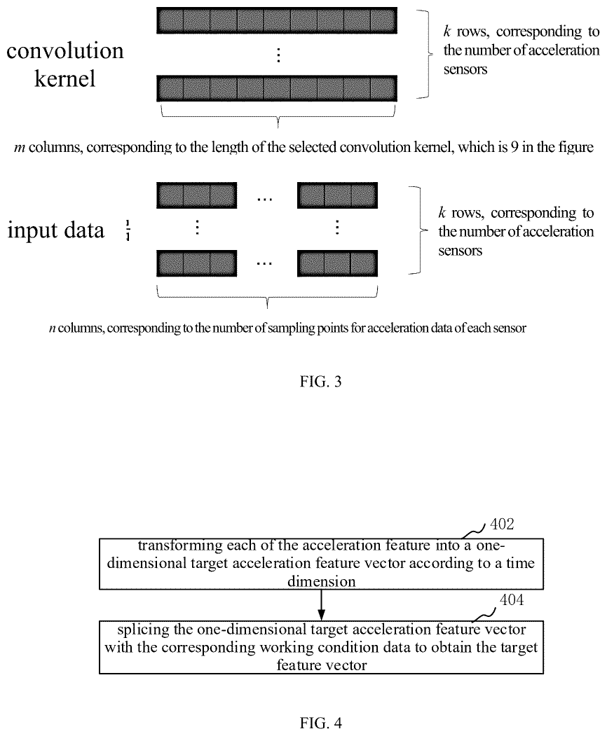

For example, as shown in FIG. 3, a convolution kernel length (m) and the number of convolution layers are adjusted by pending tasks of the pavement condition recognition model, and the number of input layers of the convolution kernel is the same as the number of acceleration sensors. k denotes the number of acceleration sensors, and the acceleration data collected by each acceleration sensor consists of n sampling points, then the acceleration data collected by all acceleration sensors can be transformed into k vectors each having a of size n, constituting a matrix of k×n, which is used as the inputs of the convolutional neural network. In the convolution layer of the convolutional neural network, different convolutional kernels may be used to perform convolutional operations on the input channels respectively, and each convolved feature map represents feature information of the corresponding channel. Therefore, each convolution operation will be performed based on k acceleration vectors distributed over k channels, and for each channel an output feature vector can be obtained, which ultimately determines the feature matrix of k×n, i.e., the acceleration features of the current pavement.

In Step 206, splice each of the acceleration features with corresponding working condition data to determine a target feature vector.

In an embodiment of the present disclosure, during the pavement condition recognition, in addition to the acceleration data, the working condition data parameters (e.g., a vehicle speed, a temperature, a humidity, an axle weight, a vehicle type, a road structure size, a joint form, etc.) may also provide some feature information for recognizing pavement damages. Therefore, the terminal splices corresponding work condition data with each of the acceleration features to obtain a comprehensive target feature vector.

In Step 208, determine a pavement damage identification result based on the target feature vectors and a multi-layer perceptron of the pavement condition recognition model.

In an embodiment of the present disclosure, the terminal inputs the target feature vectors into the multi-layer perceptron of the pavement condition recognition model, and the multi-layer perceptron processes the data of the target feature vector and outputs the pavement damage identification results. The multi-layer perceptron includes an input layer and an output layer, the number of nodes in the input layer is the same as the size of the target feature vectors, and the number of nodes in the output layer is the same as the number of pavement damage classification results.

In the above pavement condition determining method, the feature extraction is performed on the acceleration data by the convolutional neural network of the pavement condition recognition model to obtain the acceleration features, which can monitor the internal damage of the pavement, and each of the acceleration features are spliced with the corresponding working condition data to obtain a target feature vector, which can improve the complexity of the target feature vector, so that the generalization ability of the classification computation performed on the target feature vectors by the multi-layer perceptron of the pavement condition recognition model is improved, thereby improving the accuracy of the pavement damage recognition.

In an embodiment, as shown in FIG. 4, step 206 of splicing each of the acceleration features with the corresponding work condition data to determine the target feature vector, includes step 402 and step 404.

In Step 402, transform each of the acceleration features into a one-dimensional target acceleration feature vector according to a time dimension.

In an embodiment of the present disclosure, the terminal transforms each of the acceleration features into the one-dimensional target acceleration feature vector according to the method of matrix deformation and flattening according to a time dimension. For example, the terminal flattens each row (i.e., each acceleration feature corresponding to the acceleration data collected by each acceleration sensor) of the acceleration feature matrix of k×n into a vector with length n, and connects each flattened vector in a row order into a one-dimensional vector with a length k⋅n, i.e., the target acceleration feature vector.

In Step 404, splice the one-dimensional the target acceleration feature vector with the corresponding working condition data to obtain the target feature vector.

In an embodiment of the present disclosure, the terminal splices the one-dimensional acceleration feature vector with the corresponding working condition data of the current road environment to obtain the target feature vector for pavement condition recognition, and the target feature vector is a one-dimensional vector.

In an embodiment, the pavement condition recognition model may include a data splicing layer for splicing each of the target acceleration feature vectors with the corresponding working condition data. The data splicing layer may splice two inputted tensors in a particular order to generate a new tensor.

In this embodiment, by transforming each of the acceleration features into the one-dimensional target acceleration feature vector, the corresponding work condition data can be spliced with the target acceleration feature vector to obtain the target feature vector having a higher complexity, and by classifying the pavement damage based on the target feature vector, the accuracy of the determination of the classification results of the pavement damage can be improved.

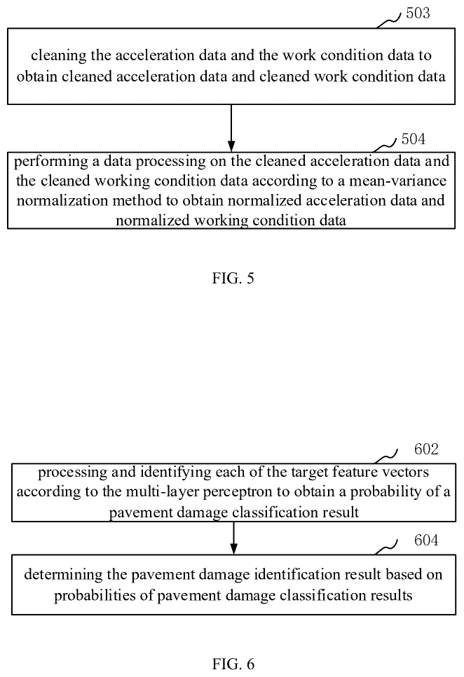

In an embodiment, as shown in FIG. 5, before step 202 of acquiring the acceleration data and the working condition data, the method further includes steps 503 and 504.

In Step 503, clean the acceleration data and the work condition data to obtain cleaned acceleration data and cleaned working condition data.

In an embodiment of the present disclosure, in actual engineering applications, among the acceleration data and the working condition data, some may miss values or some may be abnormal values. These undesirable data will adversely affect the subsequent data processing and model constructing. Therefore, the terminal first cleans the collected acceleration data and working condition data, removes the acceleration data and/or working condition data which miss values or are abnormal values, and obtains the cleaned acceleration data and the cleaned working condition data.

In an embodiment, for the missing values or abnormal values that may exist in the acceleration data and the working condition data, the terminal may perform data filling for the missing values according to an average value, a median, and a mode. The average value is used to fill continuous-type data, and the median or the mode is used to fill discrete-type data. For the abnormal values existing in the acceleration data and the working condition data, the terminal may replace the abnormal values according to the average value, the median, and so on in the statistical method, or replace the abnormal values according to the Lagrange interpolation method, the spline interpolation method, the ridge regression, and so on.

In Step 504, perform a data processing on the cleaned acceleration data and the cleaned working condition data according to a mean-variance normalization method to obtain normalized acceleration data and normalized working condition data.

In an embodiment of the present disclosure, after the acceleration data and the working condition data are cleaned, the terminal performs the data processing on the cleaned acceleration data and the cleaned working condition data according to the mean-variance normalization method, and transforms the acceleration data and the working condition data having different scales and ranges to those having same scales and ranges, as shown in the following equation:

$${x}_{i} = \frac{{X}_{i} - μ}{σ}$$

Where Xᵢ represents each of the acceleration data or working condition data; μ and σ represent a mean and a standard deviation of the data, respectively.

In this embodiment, the accuracy of the input data of the pavement damage model can be improved by performing the data cleaning on the acceleration data and the working condition data, and the acceleration data and the working condition data are normalized by the mean-variance normalization method, so that the acceleration data and the working condition data can be processed in the pavement condition recognition model, thereby improving the accuracy of the pavement damage recognition.

In an embodiment, as shown in FIG. 6, step 208 of determining the pavement damage identification result based on the target feature vectors and the multi-layer perceptron of the pavement condition recognition model includes steps 602 and 604.

In Step 602, process and identify each of the target feature vectors according to the multi-layer perceptron to obtain a probability of a pavement damage classification result.

In an embodiment of the present disclosure, the Multi-Layer Perception (MLP) includes an input layer, a hidden layer, and an output layer. The input layer, the hidden layer, and the output layer are fully connected layers, and the hidden layer is used to carry out a classification processing on the target feature vectors. The terminal inputs the target feature vectors to the multi-layer perceptron, and each of the target feature vectors is classified by the hidden layer to obtain a predetermined probability of a pavement damage classification result. In an embodiment, the output layer of the multi-layer perceptron is a softmax activation function (a name of an activation function), and the input layer and the hidden layer are both Relu activation functions (a name of an activation function).

In Step 604, determine a pavement damage identification result based on the probabilities of pavement damage classification results.

In an embodiment of the present disclosure, the terminal determines the pavement damage classification result, which has the highest probability value among the probabilities of all pavement damage classification results obtained by the multi-layer perceptron, to be the pavement damage identification result. For example, the predetermined pavement damage classification results may include four classification results, namely a normal pavement, a pavement with voids beneath the slab, a pavement with bottom slab cracks, and a pavement with voids beneath the slab and bottom slab cracks. The terminal determines the pavement damage classification result, which has the highest probability value among the four pavement damage classification results, to be the final pavement damage identification result. The predetermined pavement classification results are not limited in the embodiments of the present disclosure.

In this embodiment, by processing and recognizing the target feature vectors by the multi-layer perceptron, the damage identification result of the current pavement may be determined, thereby realizing the monitor of the internal damage of the pavement.

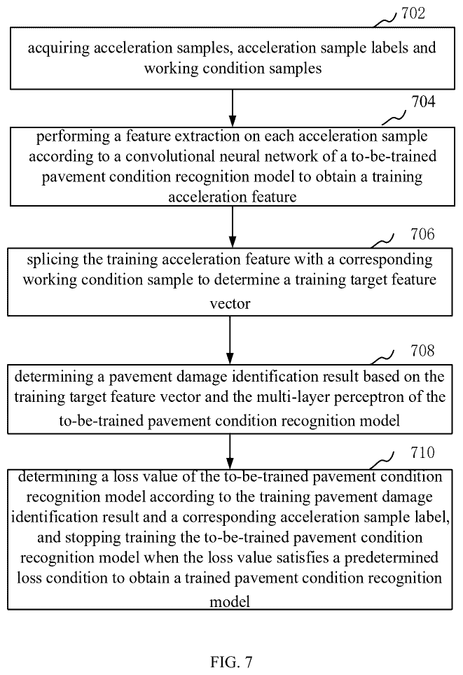

In an embodiment, as shown in FIG. 7, the method further includes steps 702 through 710.

In Step 702, acquire acceleration samples, acceleration sample labels, and working condition samples.

Each acceleration sample label is configured to characterize the pavement damage identification result of a corresponding acceleration sample under conditions of a corresponding working condition sample.

In an embodiment of the present disclosure, the acceleration sample is collected by the acceleration sensor under the conditions of the working condition sample, and the working condition sample characterizes the working condition data of different vehicle types, loads, different environmental parameters, and different road structure sizes with different pavement damages, and different joint forms of pavement. The terminal acquires the acceleration samples and the working condition samples, and a correspondence relationship between each acceleration sample and the corresponding working condition sample. The terminal divides the acceleration samples and the working condition samples into a training set, a validation set and a test set according to a predetermined ratio, which may be 0.9:0.09:0.01.

In Step 704, perform a feature extraction on each acceleration sample according to a convolutional neural network of a to-be-trained pavement condition recognition model to obtain a training acceleration feature.

In an embodiment of the present disclosure, the terminal inputs the acceleration sample to the to-be-trained convolutional neural network of the pavement condition recognition model, and the convolutional neural network performs the feature extraction on the acceleration sample to obtain the training acceleration feature under conditions of the working condition sample.

In an embodiment, the convolutional neural network of the to-be-trained pavement condition recognition model includes a convolutional layer, a pooling layer, and a fully connected layer. The convolution layer may extract the training acceleration feature of the acceleration sample, the pooling layer is configured to reduce the dimensionality of the training acceleration feature, and the fully connected layer is configured to output the training acceleration feature that is extracted based on the acceleration sample.

In step 706, splice the training acceleration feature with a corresponding working condition sample to determine a training target feature vector.

In the embodiments of the present disclosure, during the training of the to-be-trained pavement condition recognition model, the training acceleration feature is usually not sufficient to fully describe the pavement damage, so the terminal splices the training acceleration feature with the feature characterized by the corresponding work condition sample to form a complete training target feature vector. The terminal splices the training acceleration feature with the corresponding working condition sample to obtain a more comprehensive training target feature vector.

In Step 708, determine a pavement damage identification result based on the training target feature vector and the multi-layer perceptron of the to-be-trained pavement condition recognition model.

In an embodiment of the present disclosure, the terminal inputs the training target feature vector into the multi-layer perceptron of the to-be-trained pavement condition recognition model, trains the to-be-trained damage recognition model, and data of the training target feature vector is processed by the multi-layer perceptron to output a training pavement damage identification result, and the training pavement damage identification result, combining with the acceleration sample label, is configured to calculate a loss value of the current to-be-trained pavement condition recognition model.

In Step 710, determine the loss value of the to-be-trained pavement condition recognition model according to the training pavement damage identification result and a corresponding acceleration sample label, and stop training the to-be-trained pavement condition recognition model when the loss value satisfies a predetermined loss condition to obtain a trained pavement condition recognition model.

In an embodiment of the present disclosure, the terminal determines a loss value of the to-be-trained pavement condition recognition model of the current model parameters according to the training pavement damage identification result and the acceleration sample label. The predetermined loss condition may be an error threshold between the loss value and the acceleration sample label, and when the error between the loss value and the acceleration sample label is less than the error threshold, the loss value satisfies the predetermined loss condition, and the terminal stops training the to-be-trained pavement condition recognition model to obtain the trained pavement condition recognition model. In an embodiment, the loss function of the to-be-trained pavement condition recognition model may be a cross-entropy loss function, and a specific formula of which is shown as follows:

$$Loss = - \frac{1}{N} {\sum }_{i} {\sum }_{c = 1}^{M} {y}_{ic} log ( {p}_{ic} )$$

Where M denotes a total number of damage categories, c denotes different categories, i denotes different acceleration samples, p_{ic} denotes a predicted probability that sample i belongs to a damage category c, y_{ic} only has two values, 0 and 1, when the predicted probability of the acceleration sample i belonging to a certain damage category is 1, the probability of the acceleration sample i belonging to any other damage category is 0.

In this embodiment, by training the to-be-trained pavement condition recognition model, the trained pavement condition recognition model is obtained, thereby improving the accuracy of the pavement damage recognition of the trained pavement condition recognition model

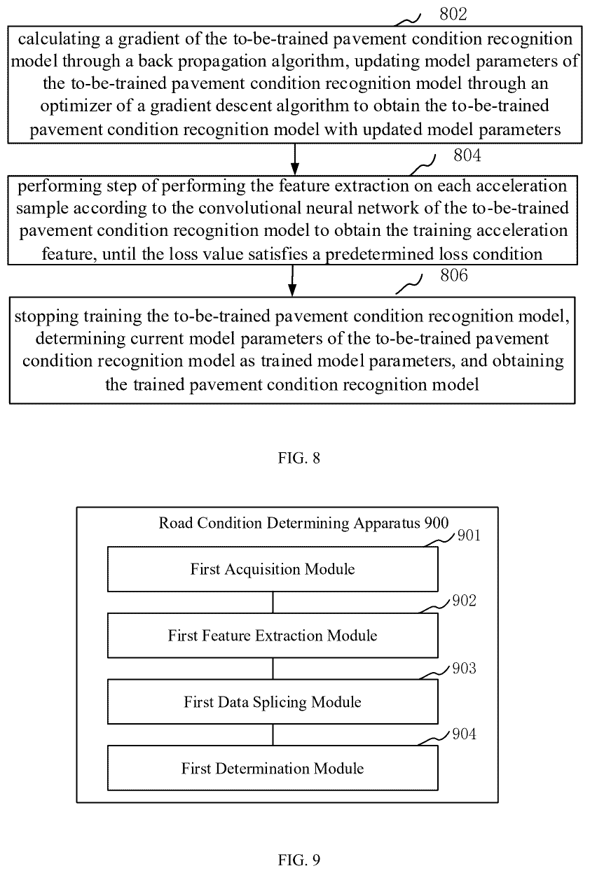

In an embodiment, as shown in FIG. 8, the step 710 of determining the loss value of the to-be-trained pavement condition recognition model according to the training pavement damage identification result and the acceleration sample label, and stopping training the to-be-trained pavement condition recognition model when the loss value satisfies a predetermined loss condition to obtain the trained pavement condition recognition model, includes steps 802 to 806.

In Step 802, calculate a gradient of the to-be-trained pavement condition recognition model through a back propagation algorithm, and update model parameters of the pavement condition recognition model through an optimizer of a gradient descent algorithm, and obtain the to-be-trained pavement condition recognition model with updated model parameters.

In an embodiment of the present disclosure, after the terminal determines the loss value based on the error between the training pavement damage identification result of the to-be-trained pavement condition recognition model and the acceleration sample label, the gradient of the pavement condition recognition model is calculated by means of a back propagation algorithm, and the model parameters of the to-be-trained pavement condition recognition model are updated by means of the optimizer of the gradient descent algorithm. The optimizer of the gradient descent algorithm may be an adaptive moment estimation, (Adam), which adaptively adjusts a learning rate of the to-be-trained pavement condition recognition model in the gradient descent process to avoid a convergence to a local optimum. The terminal continuously updates the model parameters of the to-be-trained pavement condition recognition model according to the adaptively adjusted learning rate, and obtains the to-be-trained pavement condition recognition model with updated model parameters.

In Step 804, return to and perform the step of performing a feature extraction on the acceleration sample according to the convolutional neural networks to obtain the acceleration features, until the loss value satisfies the predetermined loss condition.

In an embodiment of the present disclosure, after the terminal updates the model parameters of the pavement condition recognition model each time by means of the optimizer of the gradient descent algorithm, the terminal continues to perform a step of calculating the loss value of the pavement condition recognition model with the current model parameters, including obtaining the acceleration features by performing the feature extraction on the acceleration sample based on the convolutional neural network, and then, splicing the acceleration features with the working condition sample to determine the target feature vector, and obtaining the pavement damage identification result corresponding to the acceleration sample based on the multi-layer perceptron of the pavement condition recognition model with the current model parameters, and obtaining the loss value of the pavement condition recognition model based on this pavement damage identification result and the acceleration sample label. The terminal determines whether to continue updating the model parameters of the pavement condition recognition model until the loss value of the pavement condition recognition model satisfies the predetermined loss condition based on the loss value and the predetermined loss condition of the pavement condition recognition model with the current model parameters.

In Step 806, stop training the to-be-trained pavement condition recognition model, determine the current model parameters of the to-be-trained pavement condition recognition model as trained model parameters, and obtain a trained pavement condition recognition model.

In an embodiment of the present disclosure, after the loss value of the pavement condition recognition model satisfies the predetermined loss condition, it indicates that the current model parameters are the optimal model parameters for the accurate pavement condition recognition, the terminal stops iteratively updating the model parameters of the pavement condition recognition model, and determines the current model parameters of the pavement condition recognition model as the trained model parameters, so as to obtain the trained pavement condition recognition model.

In this embodiment, the gradient of the pavement condition recognition model is calculated by means of the back-propagation algorithm, and the model parameters of the pavement condition recognition model are updated by means of the optimizer of the gradient descent algorithm until the loss value satisfies the predetermined loss condition. The optimizer of the gradient descent algorithm can prevent the pavement condition recognition model from falling into the local optimal solution, thereby determining the pavement condition recognition model with updated model parameters, and improving the accuracy of pavement damage recognition.

It should be understood that although the individual steps in the flowcharts involved in the embodiments above are shown sequentially as indicated by the arrows, these steps are not necessarily executed sequentially in the order indicated by the arrows. Unless expressly stated herein, there is no strict order limitation on the execution of these steps, and these steps may be executed in other orders. Moreover, at least part of the steps in the flowchart involved in the embodiments above may include multiple steps or multiple stages, which are not necessarily executed and completed at the same moment, but may be executed at different moments, and the order of execution of these steps or stages is not necessarily sequential, but may be performed in turn or alternately with at least part of the other steps or at least a portion of steps or stages in the other steps.

Based on the same inventive concept, embodiments of the present disclosure also provide a pavement condition determining apparatus for implementing the pavement condition determining method described above. The solutions of the apparatus for solving the problem are similar to the solutions of the methods described above, therefore, for the specific limitations in one or more embodiments of the pavement condition determining apparatus provided below, reference may be made to the limitations to the pavement condition determining method described above, which will not be repeated herein.

In an embodiment, as shown in FIG. 9, a pavement condition determining apparatus 900 is provided, and includes a first acquisition module 901, a first feature extraction module 902, a first data splicing module 903, and a first determination module 904.

The first acquisition module 901 is configured to acquire acceleration data and working condition data. The acceleration data are collected by a plurality of acceleration sensors arranged inside the pavement.

The first feature extraction module 902 is configured to perform a feature extraction on the acceleration data according to a convolutional neural network of the pavement condition recognition model to obtain the acceleration features.

The first data splicing module 903 is configured to splice each of the acceleration features with the corresponding working condition data to determine a target feature vector.

The first determination module 904 is configured to determine a pavement damage identification result based on target feature vectors and a multi-layer perceptron of a pavement condition recognition model.

In an embodiment, the first data splicing module 903 is specifically configured to: transform each of the acceleration feature into a one-dimensional target acceleration feature vector according to a time dimension; and splice each of the target acceleration feature vectors with the corresponding working condition data to obtain the target feature vector.

In an embodiment, the apparatus 900 further includes a cleaning module and a normalization module.

The cleaning module is configured to clean the acceleration data and the work condition data to obtain cleaned acceleration data and cleaned working condition data.

The normalization module is configured to perform a data processing on the cleaned acceleration data and the cleaned working condition data according to a mean-variance normalization method to obtain the normalized acceleration data and the normalized working condition data.

In an embodiment, the first determining module 904 is specifically configured to: process and identify each of the target feature vectors according to the multi-layer perceptron to obtain a probability of a pavement damage classification result; and determine a pavement damage identification result based on the probabilities of pavement damage classification results.

In an embodiment, the apparatus 900 further includes: a second acquisition module, a second feature extraction module, a second data splicing module, a second determination module, and a first training module.

The second acquisition module is configured to acquire acceleration samples, acceleration sample labels, and working condition samples. Each acceleration sample label is configured to characterize pavement damage identification result of a corresponding acceleration sample under conditions of a corresponding working condition sample.

The second feature extraction module is configured to perform a feature extraction on each the acceleration sample according to a convolutional neural network of a to-be-trained pavement condition recognition model to obtain a training acceleration feature.

The second data splicing module is configured to splice the training acceleration feature with the corresponding working condition sample to determine a training target feature vector.

The second determination module is configured to determine a pavement damage identification result based on the training target feature vector and the multi-layer perceptron of the to-be-trained pavement condition recognition model.

The first training module is configured to determine a loss value of the to-be-trained pavement condition recognition model according to the training pavement damage identification result and the corresponding acceleration sample label, and when the loss value satisfies a predetermined loss condition, stop training the to-be-trained pavement condition recognition model to obtain the trained pavement condition recognition model.

In an embodiment, the first training module is specifically configured to:
calculate a gradient of the to-be-trained pavement condition recognition model by means of a back-propagation algorithm, and update the model parameters of the pavement condition recognition model by means of an optimizer of the gradient descent algorithm, and obtain the to-be-trained pavement condition recognition model with updated model parameters;
return to and perform the step of performing a feature extraction on acceleration sample according to the convolutional neural networks to obtain acceleration features, until the loss value satisfies the predetermined loss condition;
stop training the to-be-trained pavement condition recognition model, and determine the current model parameters of the to-be-trained pavement condition recognition model as trained module parameters, and obtain the trained pavement condition recognition model.

The various modules in the above pavement condition determining apparatus may be implemented in whole or in part by means of software, hardware and combinations thereof. Each of the above modules may be embedded in or independent of a processor in a computer device in the form of hardware, or may be stored in a memory in the computer device in the form of software, so as to make it convenient for the processor to call for and execute the operations corresponding to each of the above modules.

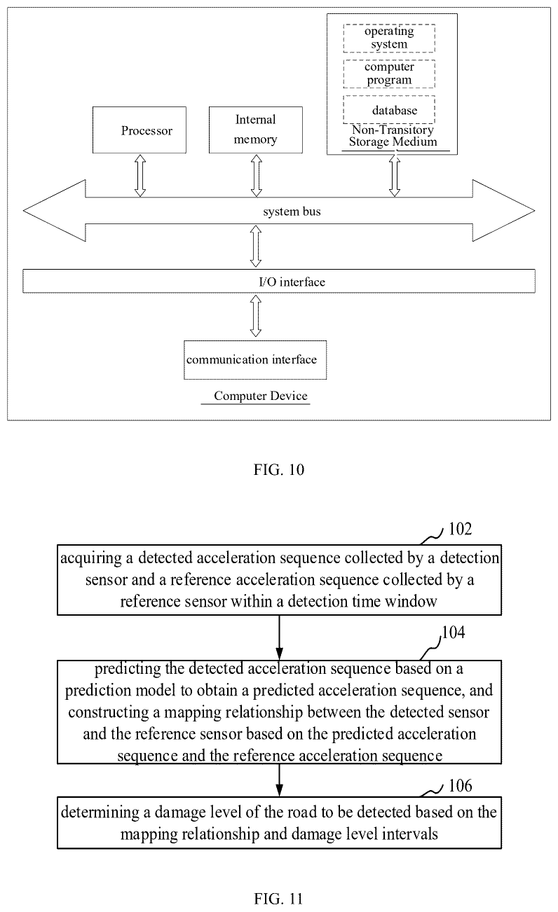

In an embodiment, a computer device is provided. The computer device may be a server, and an internal structure thereof may be shown in FIG. 10. The computer device includes a processor, a memory, and a network interface connected via a system bus. The processor of the computer device is configured to provide computing and control capabilities. The memory of the computer device includes a non-transitory storage medium and an internal memory. The non-transitory storage medium stores an operating system, a computer program, and a database. The internal memory provides an environment for the operation of the operating system and the computer program in the non-transitory storage medium. The database of the computer device is used to store acceleration data and working condition data. A network interface of the computer device is configured to communicate with an external terminal via a network connection. The computer program, when is executed by a processor, implements any one of the pavement condition determining methods above.

It would be understood by those skilled in the art that the structure illustrated in FIG. 10, which is only a block diagram showing a portion of the structure related to the solutions of the present disclosure, does not constitute a limitation on the computer device to which the present disclosure embodiment is applied, and that a specific computer device may include more or fewer components than those shown in the figure, or may combine some of the components, or may have a different arrangement of components.

In an embodiment, a computer device is provided, and includes a memory and a processor. The memory has a computer program stored therein, and the processor, when executing the computer program, implements the following steps: acquiring acceleration data and working condition data, the acceleration data being collected by a plurality of acceleration sensors arranged inside the pavement; performing a feature extraction on acceleration data according to a convolutional neural network of the pavement condition recognition model to obtain acceleration features; splicing each of the acceleration features with corresponding working condition data to determine a target feature vector; and determining the pavement damage identification result based on target feature vectors and a multi-layer perceptron of the pavement condition recognition model.

In an embodiment, the processor, when executing the computer program, further implements the following steps: transforming each of the acceleration features into a one-dimensional target acceleration feature vector according to a time dimension; and splicing the one-dimensional target acceleration feature vector with the corresponding working condition data to obtain the target feature vector.

In an embodiment, the processor, when executing the computer program, further implements the following steps: cleaning the acceleration data and the working condition data to obtain cleaned acceleration data and cleaned working condition data; performing a data processing on the cleaned acceleration data and the cleaned working condition data according to a mean-variance normalization method to obtain normalized acceleration data and normalized working condition data.

In an embodiment, the processor, when executing the computer program, further implements the following steps: processing and identifying each of the target feature vector according to the multi-layer perceptron to obtain a probability of each pavement damage classification result; and determining the pavement damage identification result based on the probabilities of pavement damage classification results.

In an embodiment, the processor, when executing the computer program, further implements the following steps: acquiring acceleration samples, acceleration sample labels and working condition samples, each of the acceleration sample labels being configured to characterize a pavement damage identification result of a corresponding acceleration sample under conditions of the corresponding working condition sample; performing a feature extraction on each acceleration sample according to a convolutional neural network in a to-be-trained pavement condition recognition model to obtain a training acceleration feature; splicing the training acceleration feature with the corresponding working condition sample to determine the training target feature vector; determining a pavement damage identification result based on the training target feature vector and the multi-layer perceptron of the to-be-trained pavement condition recognition model; determining a loss value of the to-be-trained pavement condition recognition model according to the training pavement damage identification result and the corresponding acceleration sample label, stopping training the to-be-trained pavement condition recognition model when the loss value satisfies a predetermined loss condition to obtain a trained pavement condition recognition model.

In an embodiment, the processor, when executing the computer program, further implements the following steps: calculating a gradient of the to-be-trained pavement condition recognition model through a back propagation algorithm, updating model parameters of the to-be-trained pavement condition recognition model through an optimizer of a gradient descent algorithm to obtain the to-be-trained pavement condition recognition model with updated model parameters; returning to and performing the step of performing the feature extraction on each acceleration sample according to the convolutional neural network of the to-be-trained pavement condition recognition model to obtain the training acceleration feature, until the loss value satisfies a predetermined loss condition; stopping training the to-be-trained pavement condition recognition model, determining current model parameters of the to-be-trained pavement condition recognition model as trained model parameters, and obtaining the trained pavement condition recognition model.

In an embodiment, a computer-readable storage medium is provided, and has a computer program stored thereon. The computer program, when being executed by a processor, implements the steps in each of the above method embodiments.

In an embodiment, a computer program product is provided, and the computer program product includes executable instructions. The executable instructions, when executed by a processor, implement the steps in each of the above method embodiments.

In an embodiment of the present disclosure, as shown in FIG. 11, a pavement condition determining method is provided. The pavement condition determining method is illustrated by taking the pavement condition determining method applied to a computer device as an example, and includes the following steps 102 to 106.

In Step 102, acquire a detected acceleration sequence collected by a detection sensor and a reference acceleration sequence collected by a reference sensor within a detection time window.

The detection sensor and the reference sensor are arranged according to a travelling direction of the road to be detected.

In the implementation, before the computer device executes the pavement condition determining method, a detection sensor and a reference sensor are arranged in accordance with a travelling direction of the road to be detected, and the detection sensor and the reference sensor are spaced apart by a certain distance. The detection sensor and the reference sensor respectively collect acceleration data of the road to be detected according to a predetermined sampling frequency, and transmit the acceleration data to the computer device via a communication connection. The computer device obtains the detected acceleration sequence collected by the detection sensor and the reference acceleration sequence collected by the reference sensor within a detection time window via the communication connection.

In an embodiment, sampling frequencies of the detection sensor and the reference sensor are 200 Hz (hertz), which may be reduced to obtain the acceleration data, since the response frequency of the road structure does not typically exceed 100 Hz.

In an embodiment, the detection time window may be set to, but is not limited to, 30 s (seconds), and the time duration of the detection time window is not limited in the embodiments of the present disclosure herein.

In an embodiment, the road to be detected may be, but is not limited to, a highway (road), a bridge road, and the road to be detected may be an asphalt road or a concrete road. The type of the road to be detected is not limited in the embodiments of the present disclosure.

In Step 104, predict the detected acceleration sequence based on a prediction model to obtain a predicted acceleration sequence, and construct a mapping relationship between the detected sensor and the reference sensor based on the predicted acceleration sequence and the reference acceleration sequence.

The mapping relationship is used to reflect a change in a vibration response of the road to be detected.

In the implementation, the prediction model is preset in the computer device. The computer device inputs the detected acceleration sequence into the prediction model according to the time order of the detected acceleration sequence, and the prediction model performs a prediction on the detected acceleration sequence to obtain the predicted acceleration sequence. Then, the computer device constructs the mapping relationship between the detection sensor and the reference sensor based on the time of the predicted acceleration sequence and the time of the reference acceleration sequence.

In an optional embodiment, if the number of detection sensors is 2 or more, the computer device obtains a plurality of detected acceleration sequences. The computer device integrates each of the plurality of detected accelerations of the same time within the plurality of detected acceleration sequences into a single detected acceleration vector, to obtain a detected acceleration vector sequence. The computer device inputs the detected acceleration vector sequence into the prediction model according to the time order of the detected acceleration vector sequence, and the prediction model performs a prediction processing on the detected acceleration vector sequence to obtain the predicted acceleration sequence. Then, the computer device constructs the mapping relationship between the detection sensor and the reference sensor based on the time of the predicted acceleration sequence and the time of the reference acceleration sequence.

In an embodiment, the prediction model may be, but is not limited to, a Long Short-Term Memory (LSTM) neural network, and the prediction model is not limited in embodiments of the present disclosure.

In Step 106, determine a damage level of the road to be detected based on the mapping relationship and damage level intervals.

In an embodiment, the computer device determines a damage value of the road to be detected based on a deviation value corresponding to the mapping relationship and a standard deviation corresponding to the reference acceleration sequence. Then the computer device determines a damage level corresponding to the damage value of the road to be detected based on the damage levels.

In the pavement condition determining method above, by constructing the mapping relationship between the accelerations of the detection sensor and the reference sensor which are arrange inside the road, a change in the vibration signal is obtained when a damage occurs inside the road. Furthermore, based on the mapping relationship and the damage level intervals, the damage level of the road is determined, and the damage inside the road is identified and the damage level inside the road is determined, thereby improving the accuracy of the pavement condition determining method.

In an embodiment, the detection sensor and the reference sensor are arranged along the same straight line or at a slab corner in the driving direction of the road to be detected according to the travelling direction of the road to be detected.

In the implementation, the number of both the detection sensor and the reference sensor is 1. The reference sensor is arranged in front of the detection sensor according to the travelling direction of the road to be detected, and arranged in a straight line with the detection sensor. Alternatively, the detection sensor is located at the corner of the slab of the road to be detected, and the reference sensor may also be arranged in front of the detection sensor and at the corner of the slab of the road to be detected.

In an optional embodiment, the detection sensors include a first detection sensor and a second detection sensor. The reference sensors include a first reference sensor and a second reference sensor. The first detection sensor and the second detection sensor are arranged on two sides of the road, respectively. The first reference sensor and the second reference sensor are arranged in front of the first and second detection sensors respectively according to the travelling direction of the road to be detected. The lines connecting the locations of the first detection sensor, the second detection sensor, the first reference sensor and the second reference sensor form a rectangular.

In an optional embodiment, the detection sensors include the first detection sensor and the second detection sensor. The number of the reference sensor is 1. The first detection sensor and the second detection sensor are arranged on two sides of the road, respectively. The reference sensor is arranged in front of the first detection sensor in a straight line with the first detection sensor according to the travelling direction of the road to be detected. The lines connecting the locations of the first detection sensor, the second detection sensor and the first reference sensor form a right triangle.

In an embodiment, the number of detection sensor is at least 1, and the number of reference sensor is at least 1. The numbers of detection sensors and reference sensors are not limited in the embodiments of the present disclosure.

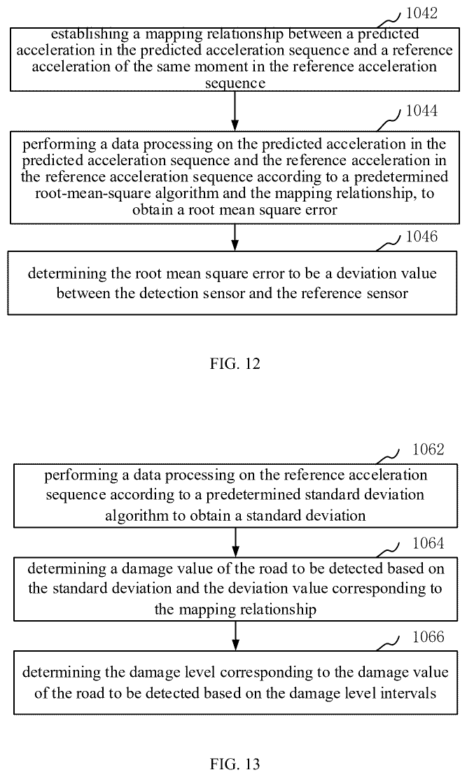

In an embodiment, as shown in FIG. 12, the specific process of step 104 of constructing the mapping relationship between the detection sensor and the reference sensor based on the predicted acceleration sequence and the reference acceleration sequence includes steps 1042 through 1046.

In Step 1042, establish a mapping relationship between a predicted acceleration in the predicted acceleration sequence and a reference acceleration of the same moment in the reference acceleration sequence.

In an embodiment, the computer device determines a predicted acceleration in the predicted acceleration sequence and a reference acceleration in the reference acceleration sequence, which are of the same moment, according to the time order of the predicted acceleration sequence. Then the computer device establishes the mapping relationship between the predicted acceleration and the reference acceleration.

In Step 1044, perform a data processing on the predicted acceleration in the predicted acceleration sequence and the reference acceleration in the reference acceleration sequence according to a predetermined root-mean-square algorithm and the mapping relationship, to obtain a root mean squared error (RMSE).

In the implementation, the root-mean-square algorithm is preset in the computer device. The computer device, based on the preset root-mean-square algorithm, performs the data processing on the predicted acceleration in the predicted acceleration sequence and the reference acceleration to which that predicted acceleration is mapped, to obtain the RMSE.

In Step 1046, determine the RMSE to be a deviation value between the detection sensor and the reference sensor.

In the implementation, the computer device determines the RMSE as a deviation value between the detection sensor and the reference sensor. When the deviation value is relatively small, it means that the mapping between the detection sensor and the reference sensor has not changed and no damage has occurred on the road to be detected. When the deviation value gradually rises, it means that the change in the mapping between the detection sensor and the reference sensor is gradually increasing, and that the damage value of the road to be detected is increasing, and the damage degree of the road to be detected is also increasing.

In an optional embodiment, the damage inside the road includes a void damage in road slab, or a road shift, and the like. In the case that a void damage in road slab occurs to the road to be detected, a mapping relationship between the detection sensor and the reference sensor is constructed. When a vehicle passes over the road to be detected, the internal structure of the road vibrates in response, and a difference between the reference acceleration obtained by the reference sensor and the reference acceleration obtained under normal pavement conditions gradually increases. Further, the change the mapping between the detection sensor and the reference sensor gradually increases, and the damage value of the road to be detected continuously increases, and the damage degree of the road to be detected also continuously increases.

In the embodiment, when damage occurs inside the road, by performing the prediction processing on the acceleration sequence and the reference acceleration sequence, and by constructing the mapping relationship between the accelerations of the detection sensor and reference sensor arranged inside the road, the change in the vibration signals is obtained.

In an embodiment, as shown in FIG. 13, the specific process of step 106 includes steps 1062 through 1066.

In Step 1062, perform a data processing on the reference acceleration sequence according to a predetermined standard deviation algorithm to obtain a standard deviation.

In the implementation, a standard deviation algorithm is preset in the computer device. The computer device performs a standard deviation operation on the reference acceleration sequence based on the preset standard deviation algorithm, to obtain a standard deviation.

In Step 1064, determine a damage value of the road to be detected based on the standard deviation and the deviation value corresponding to the mapping relationship.

In the implementation, the computer device performs a division operation on the standard deviation and the deviation value corresponding to the mapping relationship based on a predetermined formula for the damage value, to obtain the damage value of the road to be detected. The damage value is shown in following formula:

$$T = RMSE / σ$$

Where T denotes the damage value of the road to be detected, RMSE denotes the deviation value, and σ denotes the standard deviation. The larger the standard deviation corresponding to the reference acceleration sequence, the heavier the vehicle passing over the road. The damage of the road to be detected is not only related to the mapping relationship between the predicted acceleration sequence and the reference acceleration sequence, but also related to the overall size of the reference acceleration sequence. When a heavier vehicle passes over the pavement, it may generate a larger RMSE, thus interfering with a judgment result. Therefore, it is necessary to eliminate the error based on the standard deviation of the predicted acceleration sequence.

In Step 1066, determine a damage level corresponding to the damage value of the road to be detected based on the damage level intervals.

In the implementation, various damage level intervals are set through the computer device, and a boundary value corresponding to each damage level interval is a damage value determined through several experiments. The computer device determines the damage level among the damage level intervals corresponding to the damage value of the road to be detected.

In an optional embodiment, a plurality of thresholds H1, H2 . . . , HN are defined as boundary values of the damage level intervals. The damage levels include no damage, minor damage, and severe damage. The computer device determines a target damage level interval in which the damage value of the road to be detected is located. Then, the computer device determines a target damage level corresponding to the target damage level interval as the damage level corresponding to the damage value of the road to be detected.

In the embodiment, the damage value is determined based on the deviation value corresponding to the mapping relationship and the standard deviation of the reference acceleration sequence, thereby eliminating the influence of a vehicle weight on the damage value. The damage level of the road is determined based on the damage value and the damage level intervals, thereby identifying the damage inside the road and determining the damage degree inside the road, and improving the accuracy of the pavement condition determining method.

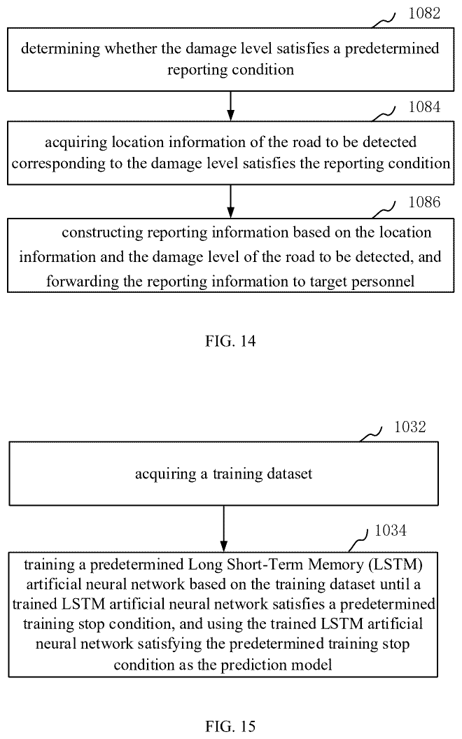

In an embodiment, after the damage level of the road to be detected is determined, it is necessary to construct reporting information based on the damage level of the road to be detected, and forward the reporting information to the target personnel. As shown in FIG. 14, after step 106, the specific processing of the pavement condition determining method further includes: steps 1082 through 1086.

In Step 1082, determine whether the damage level satisfies a predetermined reporting condition.

The reporting condition is that the damage level is not no damage.

In the implementation, the reporting condition is preset in the computer device. The computer device determines whether the damage level is no damage. If the damage level is no damage, the computer device determines that the damage level does not satisfy the predetermined reporting condition. If the damage level is not no damage, the computer device determines that the damage level satisfies the predetermined reporting condition.

In Step 1084, acquire location information of the road to be detected corresponding to the damage level satisfies the reporting condition.

In the implementation, the computer device determines an alarm level corresponding to the damage level if the damage level satisfies the reporting condition. The more severe the damage level, the higher the corresponding alarm level. At the same time, the computer device obtains the location information of the road to be detected.

In Step 1086, construct reporting information based on the location information and the damage level of the road to be detected, and forward the reporting information to target personnel.

In the implementation, the computer device constructs the reporting information based on the location information, the damage level and the alarm level of the road to be detected. Then, the computer device forwards the reporting information to the target personnel.

In an optional embodiment, the computer device constructs the reporting information based on the location information, the damage level, and the alarm level of the road to be detected. Then the computer device forwards the reporting information to the cloud. The cloud receives multiple pieces of reporting information in real time. Then, the cloud sequentially sorts the multiple pieces of reporting information according to the alarm levels in an order from high to low levels to obtain a maintenance information set. Then, the cloud forwards the reporting information to the target personnel according to the order of the maintenance information set.

In an embodiment, the target personnel may be a road maintenance personnel or road construction personnel, and the target personnel are not limited in the embodiments of the present disclosure.

In the embodiment, by constructing the reporting information and forwarding the reporting information to the target personnel, it becomes convenient for the target personnel to maintain the road to be detected, thereby improving the safety of the road to be detected.

In an embodiment, before inputting the detected acceleration sequence into the prediction model, the LSTM neural network needs to be trained to obtain the prediction model. As shown in FIG. 15, before step 104 is performed, the pavement condition determining method further includes steps 1032 and 1034.

In Step 1032, acquire a training dataset.

The training dataset includes a detection training subset and a reference training subset, and the detection training subset and the reference training subset include acceleration data of the road in a normal condition. The training dataset includes a training set, a validation set and a test set.

In an embodiment, before acquiring the training dataset, the target personnel arrange the detection sensor and the reference sensor inside a road in a normal condition. Moreover, the detection sensor and the reference sensor are arranged according to a travelling direction of the road to be detected. The computer device acquires acceleration data of the road in the normal condition collected by the detection sensor and the reference sensor. Then, the computer device constructs the training data set based on the detection time window and the acceleration data of the road.

In Step 1034, train a predetermined LSTM artificial neural network based on the training dataset until the trained LSTM artificial neural network satisfies a predetermined training stop condition, and use the trained LSTM artificial neural network that satisfies the predetermined training stop condition as the prediction model.

In an embodiment, the LSTM artificial neural network is preset in the computer device. The computer device inputs the training set from the training data set into the predetermined LSTM artificial neural network, and the LSTM artificial neural network performs a prediction processing on the training set to obtain a trained result. The computer device determines whether the trained result satisfies the predetermined training stop condition. If the trained result satisfies the predetermined training stop condition, the computer device determines that the trained LSTM artificial neural network satisfies the predetermined training stop condition. Then, the computer device uses the LSTM artificial neural network that satisfies the training stop condition as the prediction model. If the trained result does not satisfy the predetermined training stop condition, the computer device continues to train the LSTM artificial neural network until the trained result satisfies the predetermined training stop condition.

In an optional embodiment, during the training process of the LSTM artificial neural network, the computer device continuously changes the size of each parameter in the LSTM neural network according to the gradient descent method, and an activation function of the LSTM neural network is a Rectified Linear Unit (RLU) activation function, and the optimization method is an Adam method (an adaptive motion estimation algorithm), which can adaptively adjust the learning rate in the gradient descent process, thereby avoiding converging to a local extremum.

In an embodiment, the training stop condition may be the number of training rounds or the accuracy of the trained results, and the training stop condition is not limited in the embodiments of the present disclosure.

In this embodiment, the accuracy of the prediction model is improved by training the LSTM artificial neural network and using the LSTM artificial neural network that satisfies the predetermined training stop condition as the prediction model.

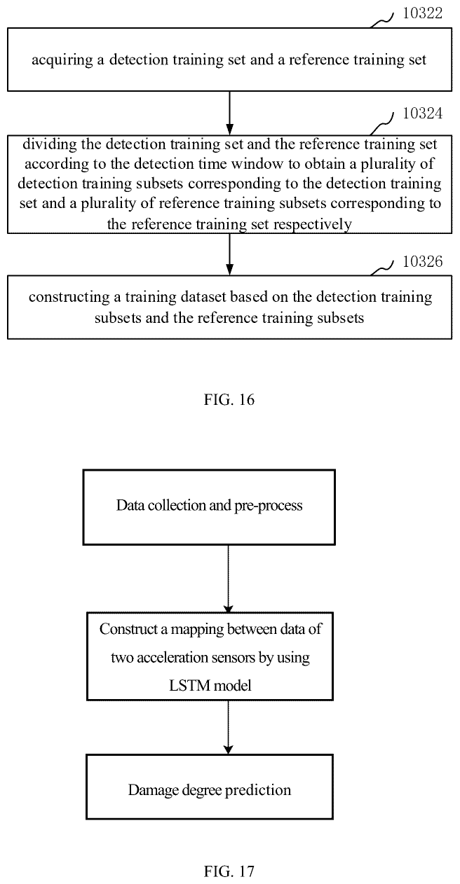

In an embodiment, as shown in FIG. 16, the specific process of step 1032 includes steps 10322 through 10326.

In Step 10322, acquire a detection training set and a reference training set.

The detection training set includes a plurality of detection training data collected by the detection sensor, and the reference training set includes a plurality of reference training data collected by the reference sensor.

In an embodiment, before acquiring the detection training set and the reference training set, the target personnel arrange the detection sensor and the reference sensor inside the road in a normal condition. The detection sensors and reference sensors are arranged according to a travelling direction of the road to be detected. The detection sensor collects a plurality of detection accelerations of the road in the normal condition according to a predetermined sampling frequency to obtain the detection training set. The computer device acquires the detection training set through a communication connection with the detection sensor. The reference sensor collects a plurality of reference accelerations of the road in the normal condition according to the predetermined sampling frequency to obtain the reference training set. The computer device acquires the reference training set through a communication connection with the reference sensor.

In Step 10324, divide the detection training set and the reference training set according to the detection time window to obtain a plurality of detection training subsets corresponding to the detection training set and a plurality of reference training subsets corresponding to the reference training set respectively.

In an embodiment, the computer device divides the detection training set according to the detection time window to obtain a plurality of detection training subsets corresponding to the detection training set. At the same time, the computer device divides the reference training set according to the detection time window to obtain a plurality of reference training subsets corresponding to the reference training set.

In an optional embodiment, the detection time window is 30 s. The computer device divides the detection training set periodically according to a time period of 30 s to obtain a plurality of detection training subsets corresponding to the detection training set. At the same time, the computer device divides the reference training set periodically according to the time period of 30 s to obtain a plurality of reference training subsets corresponding to the reference training set.

In Step 10326, construct a training data set based on the detection training subsets and the reference training subsets.

In an embodiment, the computer device constructs the training data set based on the detection training subsets and the reference training subsets. For the training data set, there is no need to consider the problem of discarding the data collected when no vehicle passes over the road, because the mapping between the detection sensor and the reference sensor when no vehicle passes over the road can be constructed based on the prediction model, and inputting the data collected when no vehicle passes over the road into the prediction model will not be alarmed.

In an optional embodiment, after obtaining the training data set, the computer device divides the training data set in accordance with a predetermined division ratio to obtain the training set, the validation set, and the test set.

In an embodiment, the division ratio of the training set, the validation set, and the test set may be, but is not limited to, 0.9:0.09:0.01. The division ratio is not limited in the embodiments of the present disclosure.

In the embodiment, the detection training set and the reference training set are divided based on the detection time window, and the training data set is constructed based on the detection training subsets and the reference training subsets obtained by division, thus obtaining the data for training the LSTM artificial neural network, and facilitating the subsequent training of the LSTM artificial neural network.

In an exemplary embodiment, as shown in FIG. 17, the computer device obtains the detected acceleration sequence by means of the detection sensor and the reference acceleration sequence by means of the reference sensor. Then, the computer device performs the prediction processing on the detected acceleration sequence based on the LSTM model to obtain the predicted acceleration sequence. The computer device constructs the mapping relationship between the detection sensor and the reference sensor based on the predicted acceleration sequence and the reference acceleration sequence. Finally, the computer device determines the damage degree of the road to be detected based on the mapping relationship and the damage level intervals.

In an optional embodiment, as shown in FIG. 18, the detection sensor collects real-time detection acceleration data to obtain the detected acceleration sequence. The reference sensor collects real-time reference acceleration data to obtain the reference acceleration sequence. The computer device acquires the detected acceleration sequence and the reference acceleration sequence, and inputs the detected acceleration sequence into the trained LSTM model (a prediction model) to obtain the predicted acceleration sequence. The predicted acceleration sequence is the predicted acceleration sequence of the reference sensor. The computer device determines the deviation value of the detection sensor and the reference sensor based on the predicted acceleration sequence and the reference acceleration sequence. The computer device then performs a standard deviation calculation on the reference acceleration sequence to obtain the standard deviation. The computer device determines the damage value (a value T) based on the deviation value and the standard deviation. The computer device determines the damage level corresponding to the damage value of the road to be detected based on the damage level intervals in which the damage value is located.

It should be understood that although the individual steps in the flowcharts involved in the embodiments above are shown sequentially as indicated by the arrows, these steps are not necessarily executed sequentially in the order indicated by the arrows. Unless expressly stated herein, there is no strict order limitation on the execution of these steps, and these steps may be executed in other orders. Moreover, at least part of the steps in the flowchart involved in the embodiments above may include multiple steps or multiple stages, which are not necessarily executed and completed at the same moment, but may be executed at different moments, and the order of execution of these steps or stages is not necessarily sequential, but may be performed in turn or alternately with at least part of the other steps or at least a portion of steps or stages in the other steps.

Based on the same inventive concept, embodiments of the present disclosure also provide a pavement condition determining apparatus for implementing the pavement condition determining method described above. The solutions of the apparatus for solving the problem are similar to the solutions of the methods described above, therefore, for the specific limitations in one or more embodiments of the pavement condition determining apparatus provided below, reference may be made to the limitations to the pavement condition determining method described above, which will not be repeated herein.

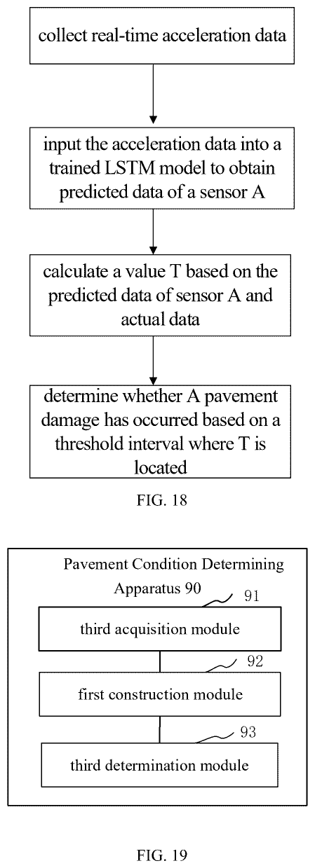

In an embodiment, as shown in FIG. 19, a pavement condition determining apparatus 90 is provided, and includes: a third acquisition module 91, a first construction module 92, and a third determination module 93.

The third acquisition module 91 is configured to acquire a detected acceleration sequence collected by a detection sensor and a reference acceleration sequence collected by a reference sensor within a detection time window. The detection sensor and the reference sensor are arranged according to a travelling direction of the road to be detected.

The first construction module 92 is configured to predict the detected acceleration sequence based on the prediction model, obtain the predicted acceleration sequence, and construct a mapping relationship between the detected sensor and the reference sensor based on the predicted acceleration sequence and the reference acceleration sequence.

A third determination module 93 is configured to determine a damage level of the road to be detected based on the mapping relationship and damage level intervals.

In an example embodiment, the detection sensors and the reference sensors are arranged in the same straight line or corner of the slab in the travelling direction of the road to be detected in accordance with the travelling direction of the road to be detected.

In an exemplary embodiment, the first construction module 92 includes a first processing submodule and a first construction submodule. The first construction submodule includes a first establishing submodule, a second processing submodule, and a first determining submodule.

A first establishing submodule is configured to establish a mapping relationship between a predicted acceleration in the predicted acceleration sequence and a reference acceleration of the same moment in the reference acceleration sequence.

A second processing submodule is configured to perform a date processing on the predicted acceleration in the predicted acceleration sequence and the reference acceleration in the reference acceleration sequence according to a predetermined root-mean-square algorithm and the mapping relationship to obtain a root mean squared error (RMSE).

A first determination submodule is configured to determine the RMSE to be a deviation value between the detection sensor and the reference sensor.

In an exemplary embodiment, the third determination module 93 includes a second processing submodule, a second determination submodule, and a third determination submodule.

The second processing submodule is configured to perform a data processing on the reference acceleration sequence according to a predetermined standard deviation algorithm to obtain a standard deviation.

The second determination submodule is configured to determine a damage value of the road to be detected based on a deviation value corresponding to the mapping relationship and the standard deviation.

The third determination submodule is configured to determine a damage level corresponding to the damage value of the pavement to be detected based on the damage level intervals.

In an exemplary embodiment, the pavement condition determining apparatus 90 further includes a judgment module, a first acquisition submodule, and a second construction module.

The judgment module is configured to determine whether the damage level satisfies a predetermined reporting condition.

The first acquisition submodule is configured to acquire location information of the road to be detected if the damage level satisfies the reporting condition.

The second construction module is configured to construct the reporting information based on the location information of the road to be detected and the damage level, and forward the reporting information to the target personnel.

In an exemplary embodiment, the pavement condition determining apparatus 90 further includes a second acquisition submodule and a second training module.

The second acquisition submodule is configured to acquire a training data set. The training data set includes a detection training subset and a reference training subset, the detection training subset and the reference training subset includes acceleration data of the road in a normal condition.

The second training module is configured to train a predetermined LSTM artificial neural network based on the training data set until the trained LSTM artificial neural network satisfies a predetermined training stop condition, and using the LSTM artificial neural network satisfying the training stop condition as the prediction model.

In an exemplary embodiment, the second acquisition submodule includes: an acquisition submodule for detection training set and reference training set, a dividing submodule, and a second construction submodule.

The acquisition submodule for detection training set and reference training set is configured to acquire a detection training set and a reference training set. The detection training set includes a plurality of detection training data collected by a detection sensor, and the reference training set includes a plurality of reference training data collected by a reference sensor.

The dividing submodule is configured to divide the detection training set and the reference training set respectively according to the detection time window to obtain a plurality of detection training subsets corresponding to the detection training set and a plurality of reference training subsets corresponding to the reference training set.

The second construction submodule is configured to construct a training data set based on the detection training subsets and the reference training subsets.

The various modules in the above pavement condition determining apparatus may be implemented in whole or in part by software, hardware and combinations thereof. Each of the above modules may be embedded in or independent of a processor in a computer device in the form of hardware, or may be stored in a memory in a computer device in the form of software, so as to make it convenient for the processor to call for and perform operations corresponding to each of the modules above.

In an embodiment, a computer device is provided. The computer device may be a terminal, and an internal structure thereof may be shown in FIG. 10. The computer device includes a processor, a memory, a communication interface, a display, and an input apparatus connected via a system bus. The processor of the computer device is configured to provide computing and control capabilities. The memory of the computer device includes a non-transitory storage medium, an internal memory. The non-transitory storage medium stores an operating system and a computer program. The internal memory provides an environment for the operation of the operating system and the computer program in the non-transitory storage medium. The communication interface of the computer device is configured to communicate with an external terminal in a wired or wireless mode, and the wireless mode is implemented by WIFI, mobile cellular network, Near Field Communication (NFC) or other technologies. The computer program, when executed by a processor, implements a pavement condition determining method. The display of the computer device may be a liquid crystal display or an e-ink display, and the input apparatus of the computer device may be a touch layer covering the display, or may be a button, a trackball or a touchpad provided on the housing of the computer device, or may be an external keyboard, a touchpad, or a mouse, and the like.

It would be understood by those skilled in the art that the structure illustrated in FIG. 10, which is only a block diagram showing a portion of the structure related to the solutions of the present disclosure, does not constitute a limitation on the computer device to which the present disclosure embodiment is applied, and that a specific computer device may include more or fewer components than those shown in the figure, or may combine some of the components, or may have a different arrangement of components.

In an embodiment, a computer device is provided, and includes a memory and a processor. The memory has a computer program stored therein, and the processor, when executing the computer program, implements the steps in each of the above method embodiments.

In an embodiment, a non-transitory computer-readable storage medium is provided, and has a computer program stored thereon, and the computer program, when executed by a processor, implements the steps in each of the above method embodiments.

In an embodiment, a computer program product is provided, and includes executable instructions, and the executable instructions, when executed by a processor, implement the steps in each of the above method embodiments.

In the related technology, in order to monitor the road service pavement condition, one way is to arrange apparatus or device such as monitoring probes, ultrasonic waves, ground-penetrating radar, or LIDAR on the road, and to evaluate the road service condition based on external data about the pavement collected by these apparatuses or devices. An evaluation result that a damage occurs to the road may be obtained based on the external data about the pavement collected by these apparatuses or devices when the pavement undergoes an obvious deformation. An evaluation result that the road has not undergone any damages based on the external data about the pavement collected by these apparatuses or devices when the road interior undergoes a hollow or a void damage, which is obviously inaccurate.

Another way is to arrange a plurality of sensors inside the road, and evaluate the road service condition based on the internal data of the road collected by the sensors. When the pavement undergoes an obvious deformation or when the road interior undergoes a hollow or a void damage, the evaluation result of the damage that occurs to the road is obtained based on the data collected by the sensors. However, in the relevant technology, since the arranged sensors are relatively single, with the change of the external environment of the road, the data collected by the sensors will also change. For example, when the temperature is relatively high, a piezoelectric acceleration sensor has a strong polarization, outputs a large number of charges, and has a relatively large sensitivity. When the temperature is relatively low, the polarization thereof is weak, the piezoelectric acceleration sensor outputs a small number of charges, and the sensitivity thereof becomes relatively small. Therefore, under different road external environments and the same pavement conditions, different evaluation results will be obtained when the road is evaluated based on the data collected by the single sensors.

In addition, in the related technology, whether arranging apparatuses or devices such as the monitoring probes, the ultrasonic waves, the ground-penetrating radar, or the LIDAR on the road, or arranging multiple sensors inside the road, the collected data are needed to be uploaded to a server, and the server evaluates the pavement conditions based on the uploaded data, thus the efficiency is low and a time delay is long.

In view of the above problems, the present disclosure proposes a pavement condition determining method, and the method is applied to a control module of a collection box. The collection box includes a switch and an external environment detection sensor, and the switch is electrically connected to the control module and the external environment detection sensor respectively, the collection box is electrically connected to each acceleration sensor arranged on the road. The control module acquires an acceleration signal sequence collected by each acceleration sensor, and acquires external environment data collected by the external environment detection sensor through the switch. Processing parameters for the acceleration signal sequence are determined according to a predetermined parameter determining strategy and based on the external environment data. Based on the determined processing parameters, a feature extraction is performed on the acceleration signal sequence to obtain feature values corresponding to the acceleration signal sequence, and each feature value is evaluated according to the predetermined condition evaluation strategy to obtain the evaluation result of the pavement condition.

The pavement condition determining method of the present disclosure considers that the external environment condition directly affects the pavement condition, thus adjusting and determining each processing parameter for the acceleration data through the external environmental data, so that the processing of the acceleration data can be adjusted in accordance with the effects of the environment, thereby enabling the acceleration data to be processed more accurately, and obtaining a more accurate evaluation result. In addition, the method of the present disclosure is applied to the control module of the collection box, and can more quickly identify the pavement condition at the time of the occurrence of the damage.

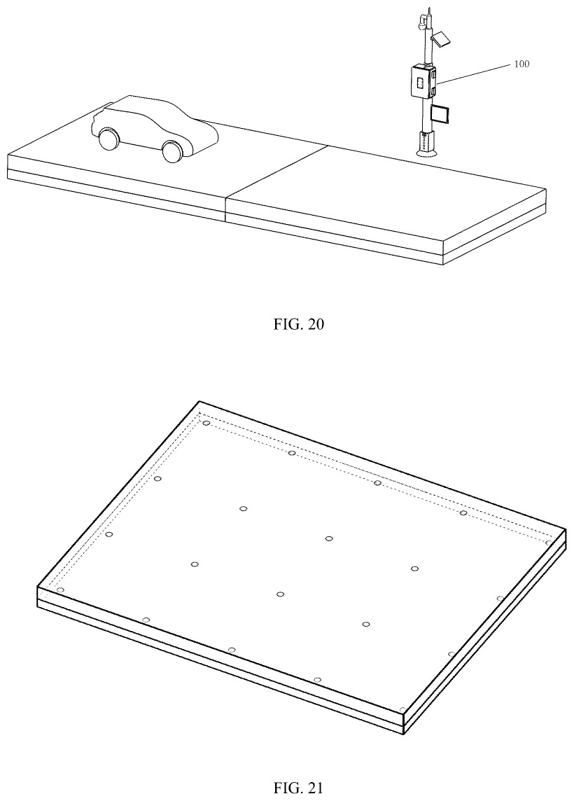

The pavement condition determining method provided by embodiments of the present disclosure can be applied to an application environment as shown in FIG. 20. The road is arranged with a plurality of acceleration sensors, and a schematic diagram of the arrangement of the acceleration sensors is shown in FIG. 21, with dots indicating the locations of the acceleration sensors arranged inside the road. The collection box 100 is fixed to a pole beside the road, and the collection box is electrically connected to each of the acceleration sensors arranged inside the road. Alternatively, the collection box 100 may also be arranged at a location closer to the road.

The collection box includes an external environmental sensor. The external environmental sensor may be arranged outside a body of the collection box, such as on top of the collection box, or may be arranged to be separated from the collection box, such as on the top of the pole, and is electrically connected to the collection box.

In an embodiment, photovoltaic panels may be further arranged on the pole in FIG. 20, and are electrically connected to the collection box to convert light energy into electrical energy to supply power for the collection box.

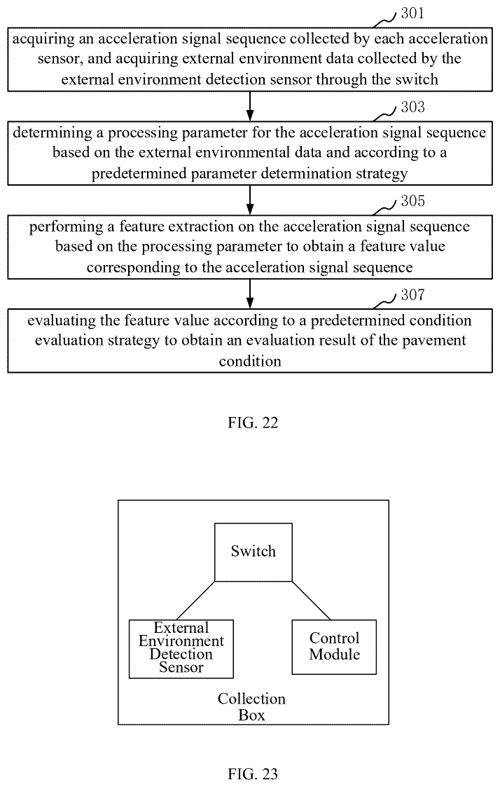

In an embodiment, as shown in FIG. 22, a pavement condition determining method is provided. The method is applied to a control module of a collection box. The collection box further includes a switch and an external environment detection sensor. The switch is electrically connected to the control module and the external environment detection sensor, and the collection box is electrically connected with the acceleration sensors arranged inside the road. The switch included in the collection box is configured to exchange data between the control module and the external environment detection sensor, and the external environment detection sensor is configured to collect external environment data, and the acceleration sensors are configured to collect acceleration data of the road.

In addition, the collection box may further include other necessary modules, such as a power supply module, a surge protector, etc., which are not listed in this application one by one.

In an embodiment, as shown in FIG. 22, the pavement condition determining method includes the following steps 301 through 307.

In Step 301, acquire an acceleration signal sequence collected by each acceleration sensor, and acquire external environment data collected by the external environment detection sensor through the switch.

The external environmental data are the environmental data outside the collection box. Since the collection box is in the same time and space as the road, the environmental data outside the collection box are equivalent to the external environmental data of the road.

Specifically, the collection box is electrically connected to each of the acceleration sensors arranged inside the road, and the control module of the collection box acquires the acceleration signal sequence collected by each of the acceleration sensors through each connected acceleration sensor. The external environment detection sensor is electrically connected to the switch, and the control module is electrically connected to the switch, therefore the control module can acquire external environment data collected by the external environment detection sensor through the switch.

In Step 303, determine a processing parameter for the acceleration signal sequence based on the external environmental data and according to a predetermined parameter determination strategy.

Specifically, when performing a feature extraction on the acceleration signal sequence, a processing parameter, such as an acceleration interception threshold interval, or a window length for filtering, etc., is involved. The processing parameter directly affects the final feature value obtained through the feature extraction, which in turn affect the evaluation result of the pavement condition. The setting of the processing parameter is associated with the external environment. For example, some acceleration sensors have higher sensitivities at a high temperature, and the acceleration interception threshold is larger. Therefore, the control module may determine the processing parameter for the acceleration signal sequence based on the external environment data and according to the predetermined parameter determination strategy.

In an embodiment, sensors for collecting weights may also be arranged on the road, and the control module determines the acceleration interception threshold interval for the acceleration signal sequence by collecting the weight of a target vehicle passing over the road, the weight of the target vehicle is proportional to the acceleration interception threshold interval, and the greater the weight of the target vehicle, the greater the acceleration interception threshold interval.

In an embodiment, the degree of solidity of the road structure may also be determined based on external environmental data. Generally, when it rains, the solidity of the road structure is poor, and when it is sunny, the solidity of the road structure is better. Based on the collected external environmental data, such as a temperature, a humidity, etc., the external environment in which the road is currently located is determined, and the degree of stability of the road structure is then determined, and then the acceleration interception threshold is determined for the acceleration signal sequence, the degree of stability of the road structure is inversely proportional to the acceleration interception threshold interval, the higher the degree of stability, the smaller the of acceleration interception threshold interval.

In Step 305, perform a feature extraction on the acceleration signal sequence based on the processing parameter to obtain a feature value corresponding to the acceleration signal sequence.

The feature value may be a peak value, a dominant frequency, or a signal energy of the acceleration signal sequence, etc.

Specifically, the control module obtains the processing parameter for the acceleration signal sequence, processes the acceleration signal sequence, and then performs the feature extraction to obtain the feature value corresponding to the acceleration signal sequence. For example, the processing parameter may be an acceleration interception threshold, and according to the determined acceleration interception threshold, a valid acceleration signal sub-sequence is intercepted for the acceleration signal sequence. Alternatively, the processing parameter may be a window time period, and according to the determined window time period, the acceleration signal sequence is filtered.

In an embodiment, the feature value may be a peak value, a dominant frequency, a signal energy of the acceleration signal sequence. The peak value is equal to Max (bₙ). After a Fourier transform is performed on the acceleration signal sequence, a frequency corresponding to the largest amplitude is the dominant frequency, and the signal energy is equal to Σ(bₙ)², where bₙ represents the acceleration signal sequence.

In Step 307, evaluate the feature value according to the predetermined condition evaluation strategy to obtain an evaluation result of the pavement condition.

Specifically, the control module performs the feature extraction on the acceleration signal sequence, and after obtaining the feature value corresponding to the acceleration signal sequence, evaluates the feature values according to a predetermined condition evaluation strategy, and obtains the evaluation result of the pavement condition. For example, if the feature value is the peak value, it is evaluated that damage may occur in the vicinity of the acceleration collector, i.e., the road may be in a condition of damage. Alternatively, if the feature value is the dominant frequency and the dominant frequency is higher than a highest dominant frequency threshold, it is evaluated that damage may occur in the vicinity of the acceleration collector, i.e., the road may be in a condition of damage. Alternatively, when the road is not in a condition of damage, there should be a mapping relationship between signal energies of accelerations collected by different acceleration sensors, and when the mapping relationship between the signal energies of accelerations collected by the acceleration sensors changes, it is evaluated that damage may occur to the road, i.e., the road may be in a damaged condition.

With respect to the specific determining methods and strategies, reference can be made to those described in the related technologies, and they will not be repeatedly described in detail herein.

In an embodiment, the condition evaluation result obtained by the pavement condition evaluation method of the present disclosure may be used as a preliminary evaluation result, based on which the sampling frequency of the acceleration sensor is further adjusted to acquire a more detailed acceleration signal sequence to perform a more accurate evaluation.

In the embodiment, considering that the environmental conditions directly affect the pavement conditions, each processing parameter for the acceleration data is adjusted based on the external environmental data, so that the processing on the acceleration data can be adjusted along with the effect of the external environment, thereby enabling the acceleration data to be processes more accurately, and further obtaining a more accurate evaluation result. In addition, the method of the present disclosure is applied to the control module of the collection box, which enables the pavement condition to be identified more quickly at the time of the occurrence of the damage.

In an embodiment, the above step 303 specifically includes: determine an acceleration interception threshold interval for the acceleration signal sequence based on the external environmental data and according to the predetermined parameter determination strategy.

The acceleration interception threshold interval is used to intercept a valid acceleration signal sub-sequence. Each acceleration signal value in the acceleration interception threshold interval is an invalid acceleration signal value. For example, in a stationary condition, the acceleration signal value is −g (g is the acceleration of gravity), and the acceleration interception threshold interval is [−1.2 g, −0.8 g], then an acceleration signal value that is greater than −0.8 g or less than −1.2 g is an effective acceleration signal value, and an acceleration signal value that is less than or equal to −0.8 g and greater than or equal to −1.2 g is an invalid acceleration signal value. For another example, in a stationary condition, an acceleration signal value is g, and the acceleration interception threshold interval is [0.8 g, 1.2 g], then an acceleration signal value that is greater than 1.2 g or less than 0.8 g is a valid acceleration signal value, and an acceleration signal value that is less than or equal to 1.2 g and greater than or equal to 0.8 g is an invalid acceleration signal value. Combined with an actual scene, when there is no target (such as people, bicycles, vehicles, etc.) travelling on the road, the road will not make a large movement, and at this time, each acceleration value in the acceleration signal sequence collected by each acceleration sensor may generally remain a value with a slight fluctuation, e.g. the value slightly fluctuating around the value-g or the value g, and a vibration amplitude of the acceleration signal collected at this time is very small, and it is impossible to determine whether a damage has occurred to the road based on this acceleration signal sequence. When a target with lighter weight travels on the road, the road may move slightly, but the movement is not large, at this time, a vibration amplitude of each acceleration signal in the acceleration signal sequence collected by each acceleration sensor is small, and it is impossible to determine whether a damage has occurred to the road based on this acceleration signal sequence. When a target with larger weight travels on the road, it will cause a larger movement of the road, and at this time, the vibration amplitude of each acceleration signal in the acceleration signal sequence collected by the acceleration sensor is larger, and a vibration amplitude of an acceleration signal in the acceleration signal sequence, which is collected by an acceleration sensor arranged in the region where the damage occurs, is larger, and based on this acceleration signal sequence, it is possible to determine whether a damage has occurred to the road more accurately. Therefore, an valid acceleration signal sub-sequence can be intercepted for the acceleration signal sequence by setting the acceleration interception threshold interval.

Specifically, the sensitivities of some of the acceleration sensors will be affected by temperature, and the control module may construct a correspondence between the temperature and the acceleration interception threshold, and determine, an acceleration interception threshold for the acceleration signal sequence under the current external environmental data based on the temperature in the external environmental data and the correspondence between the temperature and the acceleration interception threshold.

In addition, the degree of solidity of the current road structure may be determined based on the temperature and humidity of the external environmental data, and then the acceleration interception threshold can be determined based on the degree of solidity of the current road structure. Generally, when the temperature gradient is large (e.g. the temperature drops sharply on rainy days), the solidity of road structure is poor. When the temperature gradient is small (e.g. the temperature fluctuates little on sunny days), the solidity of road structure is better. When the solidity of the road structure is high, a vibration amplitude of an acceleration signal collected by an acceleration collector is small, and the acceleration interception threshold interval should be smaller. The control module may pre-construct a correspondence between the temperature and humidity in the external environment data and the degree of solidity of the road structure, and a correspondence between the degree of solidity of the road structure and the acceleration interception threshold interval. After the external environment data are acquired, the acceleration interception threshold interval for the acceleration signal sequence is determined based on the correspondence between the temperature and humidity of the external environment data and the degree of solidity of the road structure, and the correspondence between the degree of solidity of the road structure and the acceleration interception threshold interval. The degree of stability of the road structure is inversely proportional to the acceleration interception threshold interval, and the higher the degree of stability of the road structure, the smaller the acceleration interception threshold interval.

It should be noted that a size of the acceleration interception threshold interval referred to a width of the interval.

In this case, the above step 305 specifically includes step A1 and step A2.

In Step A1, intercept a valid acceleration signal sub-sequence among the acceleration signal sequence based on the acceleration interception threshold interval.

Specifically, after the control module determines the acceleration interception threshold interval, traverse each of the acceleration values in the acceleration signal sequence, determine a portion of the acceleration values that are not in the acceleration interception threshold interval, and intercept a valid acceleration signal sub-sequence from the acceleration signal sequence. For example, an acceleration value sequence corresponding to the acceleration signal sequence as aₙ (n=1, 2, 3, 4, . . . , N−1, N), the intercepted acceleration threshold interval is [aₓ, a_{y}], and the intercepted valid acceleration signal sub-sequence is aₙ′, then aₙ′ is from an and may be a continuous sequence in which none of the acceleration values is in [aₓ, a_{y}], and aₙ′ may also be a continuous sequence in which, except a starting acceleration signal value, none of the acceleration signals in an acceleration signal subsequence within a predetermined time period are in [aₓ, a_{y}], and there is an absolute value of an acceleration signal among the acceleration signal values, which is not in the acceleration interception threshold interval.

In Step A2, perform a feature extraction on the valid acceleration signal sub-sequence to obtain feature values corresponding to the acceleration signal sequence.

This step can be described with reference to step 305 and will not be repeatedly described in detail herein.

In the embodiment, the acceleration interception threshold interval used for intercepting the valid acceleration signal sub-sequence is adjusted based on the external environment data, so that the intercepted valid acceleration signal sub-sequence is more consistent with the current external environment, thereby obtaining a more accurate evaluation result.

In an embodiment, aₙ′ is a continuous sequence in the acceleration signal sub-sequence within a predetermined time period, and in aₙ′, except the starting acceleration signal value, none of the acceleration signal values are in the acceleration interception threshold interval. In this case, the above step A1 specifically includes steps A101 through A105.

In Step A101, search, among the acceleration signal sequence, a first starting acceleration signal value that is not within the acceleration interception threshold interval.

Specifically, the control module may, starting from a first acceleration value of the acceleration signal sequence, compare the acceleration value with an upper acceleration interception threshold and a lower acceleration interception threshold of the acceleration interception threshold interval, and then traverse each acceleration value in the acceleration signal sequence in turn to search the first starting acceleration signal value that is not within the acceleration interception threshold interval.

In Step A103, determine an acceleration signal sub-sequence, which has the first starting acceleration signal value as a starting acceleration signal, to be a valid acceleration signal sub-sequence, corresponding to a case where except the first starting acceleration signal value, at least one acceleration signal value among the acceleration signal values in the acceleration signal sub-sequence within the predetermined time period is not within the acceleration interception threshold interval.

Specifically, after the control module searches the first starting acceleration signal value that is not within the acceleration interception threshold interval, the control module continues to traverse the acceleration values in the acceleration signal sub-sequence within the predetermined time period starting from a sampling point of the first starting acceleration signal value, and determines whether, except the first starting acceleration signal value, each of the acceleration signal values in the acceleration signal sub-sequence within the predetermined time period is within the acceleration interception threshold interval, and if there is a respective acceleration signal value not within the acceleration interception threshold interval, i.e., among the respective acceleration signal values, if at least one acceleration signal value is not within the acceleration interception threshold interval, it indicates that the current acceleration signal sub-sequence having the first starting acceleration signal value as the starting acceleration signal is a valid acceleration signal sub-sequence, and the acceleration signal sub-sequence having the first starting acceleration signal value as the starting acceleration signal is determined to be the valid acceleration signal sub-sequence.

In Step A105, search, among the acceleration signal sequence, a second starting acceleration signal value not within the acceleration interception threshold interval, corresponding to a case where except the first starting acceleration signal value, each acceleration signal value in the acceleration signal sub-sequence within the predetermined time period is within the acceleration interception threshold interval.

Specifically, if the control module determines that each acceleration signal value is within the acceleration interception threshold interval, i.e., any one of the acceleration values is within the acceleration interception threshold interval, it indicates that the current acceleration signal sub-sequence having the first starting acceleration signal value as the starting acceleration signal is an invalid acceleration signal sub-sequence. The control module searches the second starting acceleration signal value that is not within the acceleration interception threshold interval in the acceleration signal sequence, and further determines whether, except the second starting acceleration signal value, each of the acceleration signal values in an acceleration signal sub-sequence within the predetermined time period is within the acceleration interception threshold interval.

In an embodiment, assuming that the original collected acceleration data sequence is aₙ (n=1, 2, 3, 4 . . . , N−1, N), the acceleration interception threshold interval is [ax, ay], and the intercepted valid acceleration sequence is aₙ′, then the interception method is as follows:
\textcircled{1} Start from n=1, search a value and which is not in [aₓ, a_{y}] from aₙ;
\textcircled{2} start from n=n1, record an into aₙ′;
\textcircled{3} when the data of an within a consecutive predetermined time period are all within [aₓ, a_{y}], stop recording an into aₙ′;
\textcircled{4} obtain the intercepted acceleration sequence aₙ′.

In this embodiment, a valid acceleration signal sub-sequence within the acceleration signal sequence is intercepted in a sliding manner, and the interception is more flexible, and the intercepted valid acceleration signal sub-sequence is more accurate.

In an embodiment, the above step 303 specifically includes: determine a window length for the acceleration signal sequence based on the external environmental data and according to the predetermined parameter determination strategy.

The window length is configured for filtering, and the window length is an effective time period in which the target travelling on the road approaches and then move away from the acceleration sensor.

Specifically, the external environmental data may include a travelling speed of the target on the road, and generally may include an effective travelling distance of the target travelling on the road, and a ratio of the effective travelling distance to the travelling speed may be used as a window length for performing filtering, i.e., the window length is equal to the ratio of the effective travelling distance to the travelling speed. After acquiring the external environment data, the control module determines the target travelling speed of the target travelling on the road in the external environment data, and then determines the window length for the acceleration signal sequence under the current external environment data based on the effective travelling distance and the travelling speed.

In an embodiment, the above step 305 specifically includes step B1 and step B2.

In Step B1, filter the acceleration signal sequence by a window length to obtain a filtered acceleration signal sequence.

The filtering process may be a median filtering process or a mean filtering process.

Specifically, after determining the window length for the acceleration signal sequence under the current external environmental data, the control module filters the acceleration signal sequence by the determined window length, thus realizing denoising of the acceleration signal sequence and obtaining the filtered acceleration signal sequence.

As shown below, the mean value filtering processing illustrated in the present disclosure is:

$${b}_{n} = \frac{1}{2 t + 1} {\sum }_{i = - t}^{i = t} {a}_{n + i}$$

Where 2t+1 is the window length, bₙ denotes the filtered acceleration signal sequence value, i.e., the filtered acceleration signal sequence value described above, and an denotes the acceleration signal sequence value before filtering, i.e., the acceleration signal sequence value above.

As shown below, the mean filtering process illustrated in the present disclosure is:

$${b}_{n} = Med ( {a}_{n - t} , {a}_{n - t + 1} , {a}_{n - t + 2} , … , {a}_{n + t} )$$

Where 2t+1 is the window length, bₙ denotes the filtered acceleration signal sequence value, i.e., the filtered acceleration signal sequence value described above, and an denotes the acceleration signal sequence value before filtering, i.e., the acceleration signal sequence value described above.

In Step B2, perform a feature extraction on the filtered acceleration signal sequence to obtain respective feature values corresponding to the acceleration signal sequence.

This step may be described with reference to step 305 and will not be repeatedly described in detail herein.

In the embodiment, the window length for filtering is adjusted based on the external environment data, so that the filtered acceleration signal sequence is more consistent with the current external environment, thereby obtaining the more accurate evaluation result.

In an embodiment, the above step 303 specifically includes: determining an acceleration interception threshold interval and a window length for the acceleration signal sequence based on the external environmental data and according to the predetermined parameter determination strategy.

Where, the acceleration interception threshold interval is configured to intercept a valid acceleration signal sub-sequence, and the window length is configured for filtering.

Specifically, the external environment data may include temperature data, humidity data, and may also include a travelling speed of the target on the road. The control module may construct a correspondence between the temperature and the acceleration interception threshold, and determine the acceleration interception threshold for the acceleration signal sequence under the current external environment data based on the temperature in the external environment data and the correspondence between the temperature and the acceleration interception threshold. The control module may also determine the degree of solidity of the current road structure based on the temperature and humidity of the external environment data, and then determine the acceleration interception threshold according to the degree of solidity of the current road structure. After acquiring the external environment data, the control module determines a target travelling speed of the target travelling on the road in the external environment data, and then determines the window length for the acceleration signal sequence under the current external environment data based on the effective travelling distance and the travelling speed.

In an embodiment, the above step 305 specifically includes steps C1 to C3.

In Step C1, intercept a valid acceleration signal sub-sequence among the acceleration signal sequences based on the acceleration interception threshold interval.

This step can be described with reference to step A1 and will not be repeatedly described in detail herein.

In Step C2, filter the valid acceleration signal sub-sequence by the window length to obtain the filtered acceleration signal sequence.

This step can be described with reference to step B1 and will not be repeatedly described in detail herein.

In Step C3, perform a feature extraction on the filtered acceleration signal sequence to obtain feature values corresponding to the acceleration signal sequence.

This step can be described with reference to step B2 and will not be repeatedly described in detail herein.

In this embodiment, the acceleration interception threshold interval for intercepting the valid acceleration signal sub-sequence is adjusted based on the external environment data, and the window length for filtering is adjusted based on the external environment data, so that the intercepted valid acceleration signal sub-sequence and the filtered acceleration signal sequence obtained by filtering are more consistent with the current external environment, thereby obtaining the more accurate evaluation result.

In one of the embodiments, the collection box further includes an anti-condensation dehumidifier, a radiator, and an internal environment detection sensor. The anti-condensation dehumidifier is electrically connected to the switch, and the radiator is electrically connected to the switch, and the internal environment detection sensor is electrically connected to the switch. In an embodiment, the method above may also include step 309 to step 313.

In Step 309, obtain internal environment data collected by the internal environment detection sensor through the switch.

Where, the internal environmental data is the environmental data inside the collection box, which may be temperature data, or humidity data, and the like.

Specifically, the internal environment detection sensor is electrically connected to the switch, and the control module is electrically connected to the switch. The control module may obtain the internal environment data collected by the internal environment detection sensor through the switch.

In Step 311, send a starting instruction to the anti-condensation dehumidifier through the switch in the case that the internal environment humidity data in the internal environment data reaches a predetermined internal environment humidity threshold.

Specifically, the collected internal environment will affect the operation of the collection box, and in order to ensure the normal operation of the various components of the collection box, an anti-condensation dehumidifier is provided in the collection box, and after the control module acquires the internal environment data, the internal environment humidity data in the internal environment data is compared with a predetermined internal environment humidity threshold. When the internal environment humidity data in the internal environment data is greater than the predetermined internal environment humidity threshold, the current humidity is too large, and may affect a normal operation of the collection box. The control module will send a starting instruction to the anti-condensation dehumidifier through the switch, to instruct the anti-condensation dehumidifier to perform a dehumidification processing for the collection box.

In Step 313, send a starting instruction to the radiator through the switch in the case that internal environment temperature in the internal environment data reaches a predetermined internal environment temperature threshold.

Specifically, the collected internal environment data will affect the operation of the collection box, and in order to ensure the normal operation of the various components of the collection box, the radiator is arranged in the collection box, and after the control module acquires the internal environment data, the internal environment temperature in the internal environment data is compared with the predetermined internal environment temperature threshold, and when the internal environment temperature in the internal environment data is greater than the predetermined internal environment temperature threshold, the current temperature is too high, and may affect the normal operation of the collection box, and the control module will send a starting instruction to the radiator through the switch, instructing the radiator to perform the heat dissipation processing for the collection box.

In this embodiment, the collection box is provided with the anti-condensation dehumidifier, the radiator, and the internal environment detection sensor, and when the humidity or the temperature reaches a level that may affect the normal operation of the collection box, the starting instruction will be issued to ensure the normal operation of the collection box.

In an embodiment, the collection box further includes a communication module electrically connected to the switch. The above step 301 specifically includes step 301A and step 301B.

In Step 301A, receive a remote user instruction forwarded by the communication module through the switch.

Specifically, the collection box may also be provided with a communication module, and the communication module may interact with the remote terminal by means of a wired or wireless manner, and the communication module is electrically connected to the switch, so that the remote user may issue various instructions through the remote terminal, such as starting collecting, ending collecting, timing collection, adjusting the sampling frequency, turning on or turning off the radiator and the anti-condensation dehumidifier, etc. The communication module forwards the remote user instructions sent by the remote terminal to the control module through the switch, i.e., the control module receives the remote user instructions forwarded by the communication module through the switch.

In Step 301B, acquire the acceleration signal sequence collected by each acceleration sensor upon arrival of a collection start time corresponding to the remote user instruction, and acquire the external environment data collected by the external environment detection sensor through the switch.

Specifically, the remote user instruction may be a collection start time or a collection cycle. If the remote user instruction is the collection start time, then the collection start time is the collection start time corresponding to the remote user instruction, and the control module starts executing the pavement condition determining method of the present disclosure, i.e., the control module starts executing step 301 when the collection start time corresponding to the remote user instruction has arrived. If the remote user instruction is a collection cycle, then the time that each collection cycle has arrived is the collection start time corresponding to the remote user instruction, and the control module starts executing the pavement condition determining method of the present disclosure when the collection start time corresponding to the remote user instruction has arrived, i.e., the control module starts executing step 301.

In this embodiment, the user can remotely control the operation of the collection box.

The present disclosure also provides a collection box, as shown in FIG. 23, which is a schematic view showing a structure and a connection of a collection box according to an embodiment of the present disclosure. The collection box includes a control module, a switch, and an external environment detection sensor. The switch is electrically connected to the control module and the external environment detection sensor, and the collection box is electrically connected to each acceleration sensor arranged inside the road.

The switch is configured to exchange data between the control module and the external environment detection sensor. The external environment detection sensor is configured to collect external environment data. The control module is configured to execute any one of the pavement condition determining methods above.

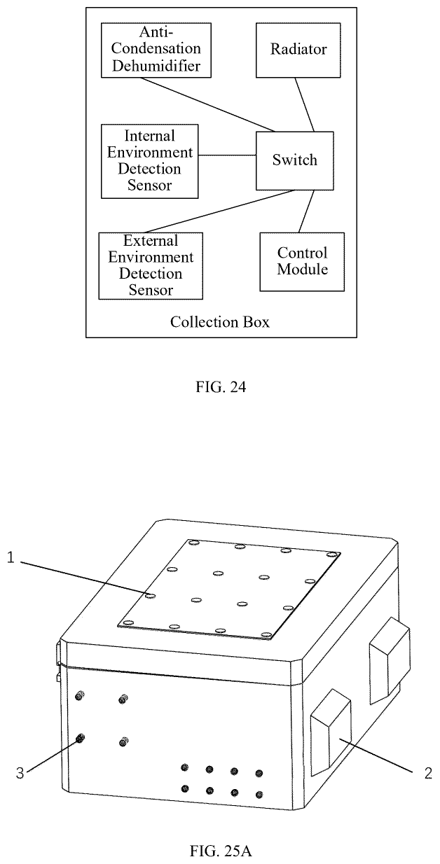

As shown in FIG. 24, a schematic view showing a structure and a connection of the collection box according to an embodiment of the present disclosure. In one of the embodiments, the collection box further includes the anti-condensation dehumidifier, the radiator, and the internal environment collection sensor.

The anti-condensation dehumidifier is configured to dehumidify the collection box according to the control of the control module. The radiator is configured to dissipate heat of the collection box according to the control of the control module. The internal environment acquisition sensor is configured to acquire internal environment data.

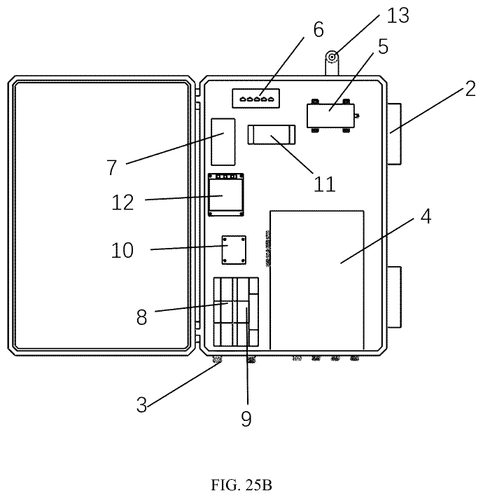

As shown in FIGS. 25A and 25B, an external schematic view as well as an internal schematic view of the collection box according to an embodiment of the present disclosure. The collection box includes collection box and sensor operation status indicators 1, a radiator 2, a waterproof interface (power input, signal input, and power output) 3, a collection and control module 4, a communication gateway 5, a switch 6, an anti-condensation dehumidifier 7, an AC power input interface 8, an DC input interface 9, an internal environment sensor 10, an anti-surge protector 11, a storage battery module 12, an antenna 13.

Waterproof interfaces 3 are mounted on a housing of the collection box, and include a DC power supply input interface, an AC power supply input interface, a camera power supply output interface, a camera signal input interface, and a sensor signal input interface.

Operation status indicators 1 are disposed on the surface of the collection box, and include a collection box operation status light and sensor operation status lights, with green light for a normal operation, and being off or with red light for malfunction or non-operation.

The surge protector 11 is disposed inside the collection box, and is configured to avoid damages to the instruments in the collection box in the case of a lightning strike.

A multi-channel acquisition board is disposed in the collection box, and is connected to the sensor access interface on the box body and configured to receive high-frequency collection data from multiple types of sensors. The acquisition board is equipped with conversion elements for different communication protocols (RS422, RS485, RS232, TTL, etc.) to implement multi-communication protocol sensor collection.

The storage battery module 12 is disposed in the collection box and configured to receive an external power supply to charge and supply power for apparatus in the box.

A hybrid power supply module is disposed in the collection box (arranged at the position indicated by 8 and 9 in FIG. 25B), and is connected to both solar power and municipal power supply. By default, the storage battery is powered by solar energy. When the storage battery's capacity is lower than 10%, the storage battery is powered by the municipal power supply, and after the power is fully charged to 100%, the storage battery is switched to be connected to the solar energy for power supply.

The internal environment sensor 10 is disposed in the collection box, and is configured to detect the temperature and humidity, etc., inside the box.

The radiator 2 and the dehumidifier are disposed in the collection box, and are configured for heat dissipation and dehumidification inside the case.

The switch 6 is disposed in the collection box, and is connected to the operating condition indicators 1, the wireless gateway, the collection board, the internal environment sensor 10, the storage battery module 12, the anti-condensation dehumidifier 7, and the radiator 2, and is configured to provide information interaction between different components.

A communication gateway is disposed in the collection box, and is configured for wireless and wired communication.

A central processor (the control module 4) is disposed in the collection box, and is connected to the switch 6, and is configured to acquire information about other components in the box through the switch 6. The central processor can be programmed in advance to control the work of the other apparatus, receive the sensor data, perform edge computation and then upload the result to the platform, i.e., perform any one of the pavement condition determining methods described above.

The central processor provided in the collection box may receive remote updates via the communication gateway 5, and may also receive remote user instructions, such as starting collection, ending collection, timing collection, adjusting the sampling frequency, and adjusting the operating status of the heat dissipation module 2 and the humidity module in the box.

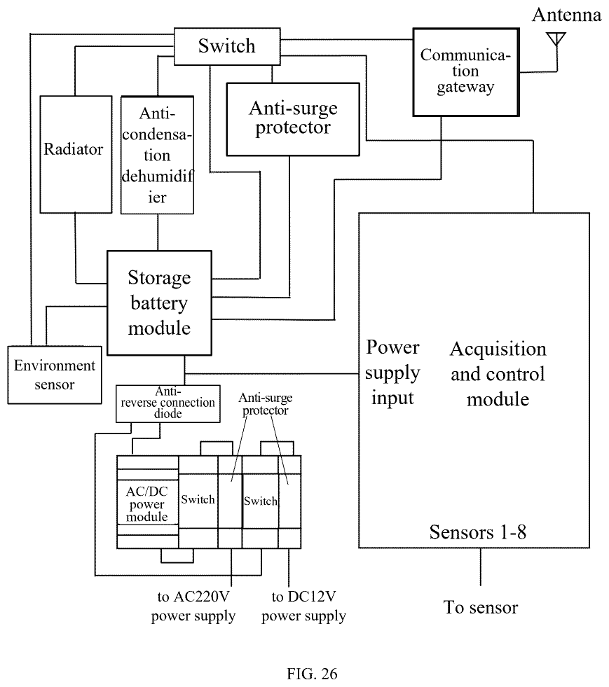

As shown in FIG. 26, a view showing an internal connection of the collection box according to an embodiment of the present disclosure. In this embodiment, the acceleration signal acquisition module and the control module are integrated into an acquisition and control module. In some embodiments, the acquisition module and the control module may be arranged separately. The acquisition module is electrically connected to each of the acceleration sensors arranged inside the road, and electrically connected to the control module for acquiring acceleration signals collected by each of the acceleration sensors and transmitting them to the control module.

It should be understood that although the individual steps in the flowcharts involved in the embodiments above are shown sequentially as indicated by the arrows, these steps are not necessarily executed sequentially in the order indicated by the arrows. Unless expressly stated herein, there is no strict order limitation on the execution of these steps, and these steps may be executed in other orders. Moreover, at least part of the steps in the flowchart involved in the embodiments above may include multiple steps or multiple stages, which are not necessarily executed and completed at the same moment, but may be executed at different moments, and the order of execution of these steps or stages is not necessarily sequential, but may be performed in turn or alternately with at least part of the other steps or at least a portion of steps or stages in the other steps.

Based on the same inventive concept, the embodiments of the present disclosure also provide a pavement condition determining apparatus configured to implement the pavement condition determining method described above. The solutions of the apparatus for solving the problem are similar to the solutions of the methods described above, therefore, for the specific limitations in one or more embodiments of the pavement condition determining apparatus provided below, reference may be made to the limitations to the pavement condition determining method described above, which will not be repeated herein.

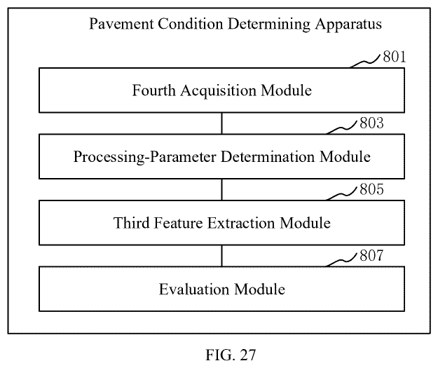

In an embodiment, as shown in FIG. 27, a pavement condition determining apparatus is provided. The apparatus is applied to a control module of a collection box, the collection box includes a switch and an external environment detection sensor, the switch is electrically connected to the control module and the environment detection sensor, respectively. The collection box is electrically connected to each acceleration sensor arranged inside a road. The pavement condition determining apparatus includes: a fourth acquisition module 801, a processing-parameter determination module 803, a third feature extraction module 805 and an evaluation module 807.

The fourth acquisition module 801 is configured to acquire an acceleration signal sequence collected by each of the acceleration sensors, and acquire external environment data collected by the external environment detection sensors through the switch.

The processing-parameter determination module 803 is configured to determine a processing parameter for the acceleration signal sequence based on the external environmental data and according to a predetermined parameter determination strategy.

The third feature extraction module 805 is configured to perform a feature extraction on the acceleration signal sequence based on the processing parameters to obtain a feature value corresponding to the acceleration signal sequence.

The evaluation module 807 is configured to evaluate the feature value according to the predetermined condition evaluation strategy to obtain an evaluation result of the pavement condition.

In an embodiment, the processing-parameter determination module 803 is specifically configured to: determine an acceleration interception threshold interval for the acceleration signal sequence based on the external environmental data and according to the predetermined parameter determination strategy.

In an embodiment, the above third feature extraction module 805 specifically includes: a first interception unit and a first feature extraction unit.

The first interception unit is configured to intercept a valid acceleration signal sub-sequence among the acceleration signal sequence based on the acceleration interception threshold interval.

The first feature extraction unit is configured to perform a feature extraction on the valid acceleration signal sub-sequence to obtain feature values corresponding to the acceleration signal sequence.

In an embodiment, the first interception unit specifically includes: a first search subunit, an interception subunit, and a second search subunit.

The first search subunit is configured to search a first starting acceleration signal value among the acceleration signal sequence that is not within the acceleration interception threshold interval.

The intercepting subunit is configured to, in an acceleration signal sub-sequence within the predetermined time period, corresponding to a case where except the starting acceleration signal value, at least one acceleration signal value among the acceleration signal values is not within the acceleration interception threshold interval, determine the acceleration signal sequence, which has the first starting acceleration signal value as a starting acceleration signal, to be a valid acceleration signal sub-sequence.

The second search subunit is configured to corresponding to the case where, except the starting acceleration signal value, each acceleration signal value in the acceleration signal sub-sequence within the predetermined time period is within the acceleration interception threshold interval, search a second starting acceleration signal value in the acceleration signal sequence, which is not within the acceleration interception threshold interval.

In an embodiment, the processing-parameter determination module 803 is specifically configured to: determine a window length for the acceleration signal sequence based on the external environmental data and according to the predetermined parameter determination strategy.

In an embodiment, the third feature extraction module 805 specifically includes: a first filtering unit and a second feature extraction unit.

The first filtering unit is configured to filter the acceleration signal sequence with a window length to obtain a filtered acceleration signal sequence.

The second feature extraction unit is configured to perform a feature extraction on the filtered acceleration signal sequence to obtain respective feature values corresponding to the acceleration signal sequence.

In an embodiment, the processing-parameter determination module 803 is specifically configured to: determine an acceleration interception threshold interval and a window length for the acceleration signal sequence based on the external environmental data and according to the predetermined parameter determination strategy.

In an embodiment, the third feature extraction module 805 specifically includes: a second interception unit, a second filtering unit, and a third feature extraction unit.

The second interception unit is configured to intercept a valid acceleration signal sub-sequence in the acceleration signal sequences based on the acceleration interception threshold.

The second filtering unit is configured to filter the valid acceleration signal sub-sequence by the window length to obtain the filtered acceleration signal sequence.

The third feature extraction unit is configured to perform a feature extraction on the filtered acceleration signal sequence to obtain feature values corresponding to the acceleration signal sequence.

In an embodiment, the collection box further includes an anti-condensation dehumidifier, a radiator, an internal environment detection sensor. The anti-condensation dehumidifier is electrically connected to the switch, the radiator is electrically connected to the switch, and the internal environment detection sensor is electrically connected to the switch. The apparatus further includes: an internal environment data acquisition module, an anti-condensation dehumidifier starting module and a radiator starting module.

The internal environment data acquisition module is configured to obtain internal environment data collected by the internal environment detection sensor through the switch.

The anti-condensation dehumidifier starting module is configured to send a starting instruction to the anti-condensation dehumidifier through the switch in the case that the internal environment humidity data in the internal environment data reaches a predetermined internal environment humidity threshold.

The radiator starting module is configured to send a starting instruction to the radiator through the switch in the case that internal environment temperature data in the internal environment data reaches a predetermined internal environment temperature threshold.

In an embodiment, the collection box further includes a communication module electrically connected to the switch. The apparatus further includes a receiving module configured to receive remote user instructions forwarded by the communication module through the switch.

In an embodiment, the fourth acquisition module 801 is configured to acquire the acceleration signal sequence collected by each acceleration sensor upon arrival of a collection start time corresponding to the remote user instruction, and acquire the external environment data collected by the external environment detection sensor through the switch.

The various modules in the above pavement condition determining apparatus may be implemented in whole or in part by software, hardware and combinations thereof. Each of the above modules may be embedded in or independent of a processor in the collection box in the form of hardware, or may be stored in a memory in a computer device in the form of software, so as to make it convenient for the processor to call for and perform operations corresponding to each of the modules above.

In an embodiment, a non-volatile computer-readable storage medium is provided and has a computer program stored thereon, and the computer program, when executed by a processor, implements the steps in each of the method embodiments.

In an embodiment, a computer program product is provided, and includes executable instructions, and the executable instructions, when executed by a processor, implement the steps in each of the above method embodiments.

It should be noted that the user information (including, but not limited to, user apparatus information, user personal information, etc.) and data (including, but not limited to, data used for analysis, stored data, displayed data, etc.) involved in the present disclosure are those authorized by the user or sufficiently authorized by all parties.

The person of ordinary skill in the art may understand that all or part of the processes in the methods of the above embodiments may be implemented by means of relevant hardware instructed by a computer program. The computer program may be stored in a non-volatile computer readable storage medium. The computer program, when executed, may include the steps of the embodiments of the methods described above. Any reference to a memory, a database, or other medium used in the embodiments provided in this application may include at least one of non-volatile and volatile memory. Non-volatile memories may include Read-Only Memory (ROM), magnetic tape, floppy disk, flash memory, optical memory, high-density embedded non-volatile memories, Resistance-Resistive Memory (ReRAM), Magnetoresistive Random Access Memory (MRAM), Ferroelectric Random Access Memory (FRAM), Phase Change Memory (PCM), Graphene Memory and so on. The volatile memory may include a Random Access Memory (RAM) or an external cache memory, etc. As an illustration and not as a limitation, the RAM may be in various forms, such as Static Random Access Memory (SRAM) or Dynamic Random Access Memory (DRAM), etc. The databases involved in the embodiments provided in the present disclosure may include at least one of a relational database and a non-relational database. The non-relational database may include, but is not limited to, a blockchain-based distributed database, etc. The processor involved in the embodiments provided in the present disclosure may be, but is not limited to, a general-purpose processor, a central processing unit, a graphics processor, a digital signal processor, a programmable logician, a data processing logician based on quantum computing, etc.

The various technical features of the above embodiments may be combined in any way, and not all possible combinations of the various technical features of the above embodiments are described for the sake of conciseness of description. However, as long as there is no contradiction in the combinations of these technical features, the combinations of the technical features should all be considered to be within the scope of the specification.

The above embodiments are only several embodiments of the present disclosure, which are described in a more specific and detailed manner, but are not to be construed as a limitation to the scope of the patent of the present disclosure. It should be pointed out that for a person of ordinary skill in the art, several deformations and improvements can be made without departing from the conception of the present disclosure, and these deformations and improvements all fall within the scope of protection of the present disclosure. Therefore, the scope of protection of this application shall be defined by the attached claims.

1. A pavement condition determining method, comprising:
acquiring acceleration data and working condition data, the acceleration data being collected by a plurality of acceleration sensors arranged inside the pavement;
performing a feature extraction on the acceleration data according to a convolutional neural network of a pavement condition recognition model to obtain acceleration features;
splicing each of the acceleration features with corresponding working condition data to determine a target feature vector; and
determining a pavement damage identification result based on target feature vectors and a multi-layer perceptron of the pavement condition recognition model.

2. The method according to claim 1, wherein splicing each of the acceleration features with the corresponding working condition data to determine the target feature vector comprises:
transforming each of the acceleration feature into a one-dimensional target acceleration feature vector according to a time dimension; and
splicing the one-dimensional target acceleration feature vector with the corresponding working condition data to obtain the target feature vector.

3. The method according to claim 1, wherein before acquiring the acceleration data and the working condition data, the method further comprises:
cleaning the acceleration data and the work condition data to obtain cleaned acceleration data and cleaned work condition data; and
performing a data processing on the cleaned acceleration data and the cleaned working condition data according to a mean-variance normalization method to obtain normalized acceleration data and normalized working condition data.

4. The method according to claim 1, wherein determining the pavement damage identification result based on the target feature vectors and the multi-layer perceptron of the pavement condition recognition model comprises:
processing and identifying each of the target feature vectors according to the multi-layer perceptron to obtain a probability of a pavement damage classification result; and
determining the pavement damage identification result based on probabilities of pavement damage classification results.

5. The method according to claim 1, further comprises:
acquiring acceleration samples, acceleration sample labels and working condition samples, each of the acceleration sample labels being configured to characterize a pavement damage identification result of a corresponding acceleration sample under conditions of a corresponding working condition sample;
performing a feature extraction on each acceleration sample according to a convolutional neural network of a to-be-trained pavement condition recognition model to obtain a training acceleration feature;
splicing the training acceleration feature with a corresponding working condition sample to determine a training target feature vector;
determining a pavement damage identification result based on the training target feature vector and the multi-layer perceptron of the to-be-trained pavement condition recognition model; and
determining a loss value of the to-be-trained pavement condition recognition model according to the training pavement damage identification result and a corresponding acceleration sample label, and stopping training the to-be-trained pavement condition recognition model when the loss value satisfies a predetermined loss condition to obtain a trained pavement condition recognition model.

6. The method according to claim 5, wherein determining the loss value of the pavement condition recognition model according to the training pavement damage identification result and the acceleration sample label, and stopping training the to-be-trained pavement condition recognition model when the loss value satisfies the predetermined loss condition to obtain the trained pavement condition recognition model comprise:
calculating a gradient of the to-be-trained pavement condition recognition model through a back propagation algorithm, updating model parameters of the to-be-trained pavement condition recognition model through an optimizer of a gradient descent algorithm to obtain the to-be-trained pavement condition recognition model with updated model parameters;
performing step of performing the feature extraction on each acceleration sample according to the convolutional neural network of the to-be-trained pavement condition recognition model to obtain the training acceleration feature, until the loss value satisfies a predetermined loss condition; and
stopping training the to-be-trained pavement condition recognition model, determining current model parameters of the to-be-trained pavement condition recognition model as trained model parameters, and obtaining the trained pavement condition recognition model.

7. A pavement condition determining method, comprising:
acquiring a detected acceleration sequence collected by a detection sensor and a reference acceleration sequence collected by a reference sensor within a detection time window, the detection sensor and the reference sensor being arranged according to a travelling direction of a road to be detected;
predicting the detected acceleration sequence based on a prediction model to obtain a predicted acceleration sequence, and constructing a mapping relationship between the detected sensor and the reference sensor based on the predicted acceleration sequence and the reference acceleration sequence; and
determining a damage level of the road to be detected based on the mapping relationship and damage level intervals.

8. The method according to claim 7, wherein the detection sensor and the reference sensor are arranged along the same straight line or at a slab corner in the travelling direction of the road to be detected according to the travelling direction of the road to be detected.

9. The method according to claim 7, wherein constructing the mapping relationship between the detection sensor and the reference sensor based on the predicted acceleration sequence and the reference acceleration sequence comprises:
establishing a mapping relationship between a predicted acceleration in the predicted acceleration sequence and a reference acceleration of the same moment in the reference acceleration sequence;
performing a data processing on the predicted acceleration in the predicted acceleration sequence and the reference acceleration in the reference acceleration sequence according to a predetermined root-mean-square algorithm and the mapping relationship, to obtain a root mean square error (RMSE); and
determining the RMSE to be a deviation value between the detection sensor and the reference sensor.

10. The method according to claim 9, determining the damage level of the road to be detected based on the mapping relationship and the damage level intervals comprises:
performing a data processing on the reference acceleration sequence according to a predetermined standard deviation algorithm to obtain a standard deviation;
determining a damage value of the road to be detected based on the standard deviation and the deviation value corresponding to the mapping relationship; and
determining the damage level corresponding to the damage value of the road to be detected based on the damage level intervals.

11. The method according to claim 7, after determining the damage level of the road to be detected based on the mapping relationship and the damage level intervals, the method further comprises:
determining whether the damage level satisfies a predetermined reporting condition;
acquiring location information of the road to be detected corresponding to the damage level satisfies the reporting condition; and
constructing reporting information based on the location information and the damage level of the road to be detected, and forwarding the reporting information to target personnel.

12. The method according to claim 7, wherein before predicting the detected acceleration sequence based on the prediction model to obtain the predicted acceleration sequence, the method further comprises:
acquiring a training dataset, the training dataset comprising a detection training subset and a reference training subset, the detection training subset and the reference training subset comprise acceleration data of the road in a normal condition; and
training a predetermined Long Short-Term Memory (LSTM) artificial neural network based on the training dataset until a trained LSTM artificial neural network satisfies a predetermined training stop condition, and using the trained LSTM artificial neural network satisfying the predetermined training stop condition as the prediction model.

13. The method according to claim 12, wherein acquiring the training dataset comprises:
acquiring a detection training set and a reference training set; the detection training set comprising a plurality of detection training data collected by the detection sensor, and the reference training set comprising a plurality of reference training data collected by the reference sensor;
dividing the detection training set and the reference training set according to the detection time window to obtain a plurality of detection training subsets corresponding to the detection training set and a plurality of reference training subsets corresponding to the reference training set respectively; and
constructing a training dataset based on the detection training subsets and the reference training subsets.

14. A pavement condition determining method, applied to a control module of a collection box, wherein the collection box comprises a switch and an external environment detection sensor; the switch is electrically connected to the control module and the external environment detection sensor; the collection box is electrically connected to each acceleration sensor arranged on a road; and the method comprises:
acquiring an acceleration signal sequence collected by each acceleration sensor, and acquiring external environment data collected by the external environment detection sensor through the switch;
determining a processing parameter for the acceleration signal sequence based on the external environmental data and according to a predetermined parameter determination strategy;
performing a feature extraction on the acceleration signal sequence based on the processing parameter to obtain a feature value corresponding to the acceleration signal sequence; and
evaluating the feature value according to a predetermined condition evaluation strategy to obtain an evaluation result of the pavement condition.

15. The method according to claim 14, wherein
determining the processing parameter for the acceleration signal sequence based on the external environmental data and according to the predetermined parameter determination strategy comprises determining an acceleration interception threshold interval for the acceleration signal sequence based on the external environmental data and according to the predetermined parameter determination strategy; and
performing the feature extraction on the acceleration signal sequence based on the processing parameter to obtain a feature value corresponding to the acceleration signal sequence comprises:
intercepting a valid acceleration signal sub-sequence among the acceleration signal sequence based on the acceleration interception threshold interval; and
performing a feature extraction on the valid acceleration signal sub-sequence to obtain feature values corresponding to the acceleration signal sequence.

16. The method according to claim 15, wherein intercepting the valid acceleration signal sub-sequence among the acceleration signal sequence based on the acceleration interception threshold interval comprises:
searching, among the acceleration signal sequence, a first starting acceleration signal value not within the acceleration interception threshold interval;
determining an acceleration signal sub-sequence having the first starting acceleration signal value as a starting acceleration signal to be a valid acceleration signal sub-sequence corresponding to a case where, except the first starting acceleration signal value, at least one acceleration signal value among the acceleration signal values in the acceleration signal sub-sequence within a predetermined time period is not within the acceleration interception threshold interval; and
searching, among the acceleration signal sequence, a second starting acceleration signal value not within the acceleration interception threshold interval, corresponding to a case where except the first starting acceleration signal value, each acceleration signal value in the acceleration signal sub-sequence within the predetermined time period is within the acceleration interception threshold interval.

17. The method according to claim 14, wherein:
determining the processing parameter for the acceleration signal sequence based on the external environmental data and according to the predetermined parameter determination strategy comprises determining a window length for the acceleration signal sequence based on the external environmental data and according to the predetermined parameter determination strategy; and
performing the feature extraction on the acceleration signal sequence based on the processing parameter to obtain a feature value corresponding to the acceleration signal sequence comprises:
filtering the acceleration signal sequence by the window length to obtain a filtered acceleration signal sequence; and
performing a feature extraction on the filtered acceleration signal sequence to obtain feature values corresponding to the acceleration signal sequence.

18. The method according to claim 14, wherein:
determining the processing parameter for the acceleration signal sequence based on the external environmental data and according to the predetermined parameter determination strategy comprises: determining an acceleration interception threshold interval and a window length for the acceleration signal sequence based on the external environmental data and according to the predetermined parameter determination strategy; and
performing the feature extraction on the acceleration signal sequence based on the processing parameter to obtain a feature value corresponding to the acceleration signal sequence comprises:
intercepting a valid acceleration signal sub-sequence among the acceleration signal sequence based on the acceleration interception threshold interval;
filtering the valid acceleration signal sub-sequence by the window length to obtain a filtered acceleration signal sequence; and
performing a feature extraction on the filtered acceleration signal sequence to obtain feature values corresponding to the acceleration signal sequence.

19. The method according to claim 14, wherein the collection box further comprises an anti-condensation dehumidifier, a radiator, and an internal environment detection sensor; the anti-condensation dehumidifier is electrically connected to the switch, the radiator is electrically connected to the switch, and the internal environment detection sensor is electrically connected to the switch; and the method further comprises:
obtaining internal environment data collected by the internal environment detection sensor through the switch;
sending a starting instruction to the anti-condensation dehumidifier through the switch in the case that internal environment humidity data in the internal environment data reaches a predetermined internal environment humidity threshold; and
sending a starting instruction to the radiator through the switch in the case that internal environment temperature data in the internal environment data reaches a predetermined internal environment temperature threshold.

20. The method according to claim 14, wherein the collection box further comprises a communication module electrically connected to the switch; and acquiring the acceleration signal sequence collected by each acceleration sensor, and acquiring external environment data collected by the external environment detection sensor through the switch comprises:
receiving a remote user instruction forwarded by the communication module through the switch;
acquiring the acceleration signal sequence collected by each acceleration sensor upon arrival of a collection start time corresponding to the remote user instruction, and acquiring the external environment data collected by the external environment detection sensor through the switch.
